(19) United States
(12) Patent Application Publication
(10) Pub. No.: US 2010/0074307 A1
(43) Pub. Date: Mar. 25, 2010

(54) A P-ORDER METRIC UWB RECEIVER STRUCTURE WITH IMPROVED PERFORMANCE IN MULTIPLE ACCESS INTERFERENCE-PLUS-NOISE MULTIPATH CHANNELS

(75) Inventors: Norman C. Beaulieu, Edmonton (CA); Hua Shao, Edmonton (CA)

Correspondence Address: SMART & BIGGAR;P.O. BOX 2999, STATION D, 900-55 METCALFE STREET, OTTAWA, ON, K1P 5Y6, CA

(73) Assignee: THE GOVERNORS OF THE UNIVERSITY OF ALBERTA, EDMONTON, AB (CA)

(21) Appl. No.: 12/598,706

(22) PCT Filed: May 5, 2008
(86) PCT No.: PCT/CA2008/000835

§ 371 Date: Nov. 3, 2009

Related U.S. Application Data
(60) Provisional application No. 60/916,033, filed on May 4, 2007.

(51) Int. Cl. H04B 1/707; H04L 27/06; H04B 17/00

(52) U.S. Cl. 375/148; 375/341; 375/224; 375/E01.002

(57) ABSTRACT

A UWB receiver dubbed the “p-order metric” receiver (p-omr) is proposed to detect the time-hopping ultra-wide bandwidth signal in multiple access interference channels. The receiver acquires a signal over a wireless channel, adaptively selects a shaping parameter, p, over time and generates a first set of partial statistics by, for each of a plurality N of observations per symbol, using the shaping parameter to modify the exponential order of the approximation of the noise plus multiple access interference probability density function, f(x), used in the receiver model.

### RELATED APPLICATION

This application claims the benefit of U.S. Provisional Patent Application No. 60/716,033 filed May 4, 2007.

### FIELD OF THE INVENTION

The invention relates to receivers and methods for performing reception of UWB (ultra-wide bandwidth) signals.

### BACKGROUND OF THE INVENTION

Ultra-wide bandwidth (UWB) wireless is a promising communication technology which is proposed as a valid solution for high-speed wireless communication systems. Several transmitters can viably coexist in the coverage area in an UWB system because of its robustness to severe multipath conditions. A time-hopping (TH) sequence is introduced to UWB systems to avoid the catastrophic collisions. Multiple access interference (MAI) for TH systems has been analyzed in M. Z. Win and R. A. Scholtz, “Ultra-Wide Bandwidth Time-Hopping Spread-Spectrum Impulse Radio for wireless Multiple-Access Communications,” IEEE Trans. Commun., vol. 48, pp. 679-691, April 2000 and A. Taha and K. M. Chugg, “A theoretical study on the effects of interference on UWB multiple access impulse radio,” in Proc. IEEE conf. on Signals, Systems and Computers, pp. 728-732, Nov. 3-6, 2002, where the MAI has been approximated as a Gaussian random variable (RV) based on the Central Limit Theorem and the conventional matched filter is used as the receiver detector. The conventional matched filter is optimal for a signal embedded in additive white Gaussian noise (AWGN) since it maximizes the output signal-to-noise ratio (SNR), J. G. Proakis, Digital Communications, 4^{th} ed. New York: McGraw-Hill, 1995, pp. 243, but the MAI in UWB systems is not Gaussian distributed. It is shown in B. Hu and N. C. Beaulieu, “Exact bit error rate of TH-PPM UWB systems in the presence of multiple access interference,” IEEE Communications Letters, vol. 7, pp. 572-574, December 2003, B. Hu and N. C. Beaulieu, “Accurate performance evaluation of time-hopping and direct-sequence UWB systems in multi-user interference,” IEEE Trans. Commun., vol. 53, pp. 1053-1062, June 2005, G. Durisi and G. Romano, “On the validity of Gaussian approximation to characterize the multiuser capacity of UWB TH-PPM,” in Proc. IEEE Conf. on Ultra Wideband Systems and Technologies, Baltimore, USA, May 20-23, 2002 and G. Durisi and S. Benedetto, “Performance evaluation of TH-PPM UWB systems in the presence of multiple access interference,” IEEE Commun. Lett., vol. 7, pp. 224-226, May 2003 that the “Gaussian approximation” (GA) is not accurate enough to predict the UWB system performance and it highly underestimates the BER of an UWB system when the MAI is the dominant disturbance. Therefore, the conventional matched filter UWB receiver is not necessarily an optimal receiver.

### SUMMARY OF THE INVENTION

According to one broad aspect, the invention provides a method of receiving a signal comprising: receiving a signal over a wireless channel; adaptively selecting a shaping parameter p over time; generating a first set of partial statistics by, for each of a plurality N of observations per symbol, using a receiver model based on an assumption that the noise plus MAI has a PDF f(x)=c·exp{−γ|x−Sₘ|^{p}} where p is the shaping parameter, Sₘ is the mean, and parameter γ is used to adjust the second moment of the RV, and c is a constant to ensure

$${\int }_{- ∞}^{+ ∞} f ( x ) d x = 1$$

to generate a respective partial decision statistic of the first set of partial statistics; summing the partial decision statistics to produce a first sum; making a decision on a symbol contained in the signal based on the first sum; outputting the decision.

In some embodiments, for each of a plurality N of observations per symbol, using a receiver model based on an assumption that the noise plus MAI has a PDF f(x)=c·exp{−γ|x−Sₘ|^{p}} where the parameter p is adaptive, Sₘ is the mean, and parameter γ is used to adjust the second moment of the RV, and c is a constant to ensure that

$${\int }_{- ∞}^{+ ∞} f ( x ) d x = 1$$

to generate a respective partial decision statistic comprises: transforming each observation according to:

$$\begin{matrix}{h}_{m} ( {r}_{m} ) = log \{ \frac{f ( {r}_{m} \vert {d}_{0}^{( 1 )} = 1 )}{f ( {r}_{m} \vert {d}_{0}^{( 1 )} = - 1 )} \} \\ = γ {\vert {r}_{m} + {S}_{m} \vert}^{p} - γ {\vert {r}_{m} - {S}_{m} \vert}^{p}\end{matrix}$$

where rₘ is the mth observation.

In some embodiments, the method further comprises generating each of the plurality N of observations by performing a respective correlation between the received signal at a particular time and a pulse shape.

In some embodiments, adaptively selecting p over time comprising adapting p as a function of SNR.

In some embodiments, adaptively selecting p over time comprises using kurtosis matching.

In some embodiments, adaptively selecting p over time comprises: measuring a channel condition; updating p by determining the new value for p as a function of the channel condition.

In some embodiments, adaptively selecting p over time comprises: maintaining a table lookup of p as a function of a channel condition; measuring the channel condition; updating p by looking up the new value for p using the table lookup and the measured channel condition.

In some embodiments, the method further comprises adapting a value for Sₘ used in the partial decision statistics over time.

In some embodiments, adapting a value for Sₘ used in the partial decision statistics over time comprises adapting a value Tₒₚₜ for Sₘ based on estimated channel conditions or error rate monitoring.

In some embodiments, the method is employed within a rake receiver.

In some embodiments, the method comprises: generating a respective set of partial statistics for each of a plurality of multi-path components of the received signal, one of the sets of partial statistics being said first set of partial statistics, by for each of a plurality N of observations per symbol, using a receiver model based on an assumption that the noise plus MAI has a PDF f(x)=c·exp{−γ|x−Sₘ|^{p}} where p is the shaping parameter, Sₘ is the mean, and parameter γ is used to adjust the second moment of the RV, and c is a constant to ensure that

$${\int }_{- ∞}^{+ ∞} f ( x ) d x = 1$$

to generate a respective partial decision statistic; for each multi-path component, summing the partial decision statistics to produce a respective decision statistic, one of the sums being the first sum; combining the sums to produce an overall decision statistic; wherein making a decision on a symbol contained in the signal based on the sum comprises making a decision based on the overall decision statistic.

In some embodiments, making a decision on a symbol contained in the signal based on the sum comprises making a decision based on the overall decision statistic comprises performing maximum ratio combining.

In some embodiments, receiving a signal comprises receiving a signal having a signal bandwidth that is greater than 20% of the carrier frequency, or receiving a signal having a signal bandwidth greater than 500 MHz.

In some embodiments, receiving a signal comprises receiving a signal having a signal bandwidth greater than 15% of the carrier frequency.

In some embodiments, receiving a signal comprises receiving a signal having pulses that are 1 ns in duration or shorter.

In some embodiments, receiving a signal comprises receiving a UWB signal.

In some embodiments, receiving a signal comprises receiving a TH UWB signal.

In some embodiments, receiving a signal comprises receiving a DS UWB signal.

In some embodiments, a receiver operable to implement the method as summarized above.

In some embodiments, a computer readable medium having instructions stored thereon for implementing the method as summarized above.

According to another broad aspect, the invention provides a receiver comprising: a correlator configured to generate a first set of partial statistics by, for each of a plurality N of observations per symbol, using a receiver model based on an assumption that the noise plus MAI has a PDF f(x)=c·exp{−γ|x−Sₘ|^{p}} where p is a shaping parameter, Sₘ is the mean, and parameter γ is used to adjust the second moment of the RV, and c is a constant to ensure that

$${\int }_{- ∞}^{+ ∞} f ( x ) d x = 1$$

to generate a respective partial decision statistic of the first set of partial statistics; a channel estimator configured to adapt the shaping parameter over time; an accumulator configured to sum the partial decision statistics to produce a first sum; a decision block configured to make a decision on a symbol contained in the signal based on the first sum; an output for outputting the decision.

In some embodiments, the receiver further comprises at least one antenna.

In some embodiments, the receiver further configured to adapt the mean Sₘ over time.

In some embodiments, a rake receiver comprises the receiver as summarized above.

According to another broad aspect, the invention provides a method of receiving a signal using a rake receiver, the method comprising: receiving a signal over a wireless channel; adaptively selecting a shaping parameter p over time; generating a first set of partial statistics by, for each of a plurality N of observations per symbol, using a receiver model based on an assumption that the noise plus MAI has a PDF f(x)=c·exp{−γ|x−Sₘ|^{p}} where p is the shaping parameter, Sₘ is the mean, and parameter γ is used to adjust the second moment of the RV, and c is a constant to ensure that

$${\int }_{- ∞}^{+ ∞} f ( x ) d x = 1$$

to generate a respective partial decision statistic of the first set of partial statistics; generating a respective set of partial statistics for each of a plurality of multi-path components of the received signal, one of the sets of partial statistics being said first set of partial statistics, by for each of a plurality N of observations per symbol, using a receiver model based on an assumption that the noise plus MAI has a PDF f(x)=c·exp{−γ|x−Sₘ|^{p}} where p is the shaping parameter, Sₘ is the mean, and parameter γ is used to adjust the second moment of the RV, and c is a constant to ensure that

$${\int }_{- ∞}^{+ ∞} f ( x ) d x = 1$$

to generate a respective partial decision statistic; combining the partial decision statistics to produce an overall decision statistic; wherein making a decision on a symbol contained in the signal based on the sum comprises making a decision based on the overall decision statistic.

### BRIEF DESCRIPTION OF THE DRAWINGS

Embodiments of the invention will now be described with reference to the attached drawings in which:

FIG. 1 contains plots of the simulated probability density function (pdf) θ_{y}_{ₘ}(x) of the amplitude of the overall disturbance sample in each frame, the Gaussian pdf, the Laplacian pdf and the new approximate pdf for different values of p;

FIG. 2 is a block diagram of the new UWB receiver provided by an embodiment of the invention;

FIG. 3 is a block diagram of a Rake receiver provided by an embodiment of the invention;

FIG. 4 contains plots of the average BER versus SNR of the conventional matched filter UWB receiver, the soft-limiting UWB receiver, the adaptive threshold soft-limiting UWB receiver and the p-omr with adaptive value of p determined by computer search for Ns=4 and Nu=4 when both MAI and AWGN are present;

FIG. 5 contains plots of the optimal p of the p-omr with Ns=4 and Nu=4 when both MAI and AWGN are present;

FIG. 6 contains plots of the average BER versus SNR of the conventional matched filter UWB receiver, the adaptive threshold UWB receiver and p-omatlr with optimal shape parameter p and optimal threshold Tₒₚₜ both determined by computer search for Ns=4 and Nu=4 when both MAI and AWGN are present;

FIG. 7 contains plots of the optimal p of the p-omatlr with Ns=4 and Nu=4 when both MAI and AWGN are present;

FIG. 8 contains plots of the optimal threshold Tₒₚₜ of the p-omatlr with Ns=4 and Nu=4 when both MAI and AWGN are present;

FIG. 9 contains plots of a comparison between the SINR (the factor Nₛ is omitted) in each finger of the CMF based Rake receiver and the new Rake receiver, when the estimated shape parameter \hat{p} is close to 1;

FIG. 10 contains plots of a comparison between the SINR (the factor Nₛ is omitted) in each finger of the CMF based Rake receiver and the new Rake receiver, when the estimated shape parameter \hat{p} assumes different values;

FIG. 11 contains plots of the simulated kurtosis and the theoretical kurtosis, when both MAI and AWGN are present, and the SIR=10 dB;

FIG. 12 contains plots of the shape parameter p obtained using the estimated kurtosis and the theoretical estimated kurtosis, when both MAI and AWGN are present, and the SIR=10 dB;

FIG. 13 contains plots of the optimal threshold Tₒₚₜ, normalized to Sₘ, for the p-omatlr with shape parameter p determined by the kurtosis matching method, when both MAI and AWGN are present, and the SIR=10 dB;

FIG. 14 contains plots of the average BER versus SIR of the conventional matched filter UWB receiver, the soft-limiting UWB receiver, the adaptive threshold soft-limiting UWB receiver, the p-omr with shape parameter determined using the kurtosis matching method, the p-omatlr, and the p-omr with shape parameter p determined using computer search when both MAI and AWGN are present, and the SIR=10 dB; and

FIG. 15 is a flowchart of a method of receiving a signal provided by an embodiment of the invention.

### DETAILED DESCRIPTION OF THE PREFERRED EMBODIMENTS

Some new UWB receiver structures which outperform the conventional matched filter UWB receiver have been proposed recently. A soft-limiting UWB receiver proposed in N. C. Beaulieu and B. Hu, “A Soft-limiting receiver structure for timehopping UWB in multiple access interference,” in Proc. 9th International Symposium on Spread Spectrum Techniques and Applications (ISSSTA), Manaus, Brazil, Aug. 28-31, 2006 was shown to achieve better performance than the conventional matched filter UWB receiver when only MAI is present in the channel. When both MAI and AWGN are present, the soft-limiting UWB receiver underperforms the conventional matched filter UWB receiver for small and moderate SNR, but achieves 1 dB gain for large SNR. A more complex receiver based on the soft-limiting UWB receiver was proposed in N. C. Beaulieu and B. Hu, “An Adaptive Threshold Soft-Limiting UWB Receiver with Improved Performance in Multiuser Interference”, to be presented at 2006 International Conference on Ultra-Wideband (ICUWB), Massachusetts, USA, Sep. 24-27, 2006. This adaptive threshold soft-limiting UWB receiver improves the performance of the soft-limiting UWB receiver by employing an adaptive threshold and it always meets or outperforms the conventional matched filter UWB receiver when both MAI and AWGN are present in the channel.

A new UWB receiver structure referred to herein as the “p-order metric” receiver (p-omr) is provided. In practical mixed multiuser plus Gaussian noise environments, the p-omr can meet or outperform both the conventional matched filter UWB receiver and the adaptive threshold soft-limiting UWB receiver for all SNR values and all signal-to-interference (SIR) values. Another new UWB receiver structure referred to herein as the “p-order metric adaptive threshold limiting receiver” (p-omatlr) is also provided which is on the p-omr structure. It will be shown that the p-omatlr UWB receiver design meets or surpasses the performance of all of, the conventional matched filter UWB receiver, the soft-limiting UWB receiver, the adaptive threshold soft-limiting UWB receiver, and the p-omr.

### System Model

A specific example of the form of a UWB time-hopping binary phase shift keying (TH-BPSK) signal can be described as

$${s}^{( k )} ( t ) = \sqrt{\frac{{E}_{b}}{{N}_{s}}} {\sum }_{j = - ∞}^{+ ∞} {d}_{⌊ j / {N}_{s} ⌋}^{( k )} p ( t - {jT}_{f} - {c}_{j}^{( k )} {T}_{c} ) \qquad ( 1 )$$

where s^{(k)}(t) is the signal of the kth user, t is the transmitter clock time, E_{b} is the bit energy, Nₛ is the number of frames which are used to transmit a single information bit, and dⱼ^{(k)} is the jth information bit of the kth user, which takes values from {+1, −1} with equal probabilities. The function p(t) is the transmitted UWB pulse with unit energy, which means it satisfies the condition

$${\int }_{- ∞}^{+ ∞} {p}^{2} ( t ) d t = 1.$$

Each time frame with duration T_{f} is divided into chips with duration T. The sequence WI is the time-hopping sequence for each bit of the kth user, and the product cⱼ^{(k)}T_{c} adds an additional time shift to the TH pulses to avoid catastrophic collisions. The sequence {cⱼ^{(k)}} takes integer values in the range 0≦cⱼ^{(k)}<Nₕ, where Nₕ is the number of hops which satisfies the condition NₕT_{c}≦T_{f}. It is to be clearly understood that while the embodiments described in here assume the form of the UWB signal presented above, the methods have application to other forms of UWB signals. Examples of these are given below.

Assuming ideal free-space propagation, when there are Nᵤ transmitters in the same coverage area, the received signal can be written as

$$r ( t ) = {\sum }_{k = 1}^{{N}_{u}} {A}_{k} {s}^{( k )} ( t - {τ}_{k} ) + n ( t ) \qquad ( 2 )$$

where the sequences {Aₖ}ₖ₋₁^{N}^{ᵤ} and {τ}ₖ₌₁^{N}^{ᵤ} are the attenuations and delays associated to each user, respectively. The RVs {τ}ₖ₌₂^{N}^{ᵤ} can be assumed to be uniformly distributed on [0, T_{b}), and the delay for the first user τᵢ is assumed to be known at the receiver side without loss of generality. The random process n(t) is a white Gaussian noise process with two-sided power spectral density N₀/2.

### Receiver Structure

For the purpose of this analysis, it is assumed that the signal from the first user is the desired signal and d₀⁽¹⁾ is the transmitted symbol. Of course the receiver has general applicability to any user, and to any transmitted symbol for that user. Without loss of generality, the TH sequence for the desired user, cⱼ⁽¹⁾, is set to be 0, for all j. Of course the time hopped sequence can be any appropriate value or set of values. At the receiver side, assuming perfect time synchronization, the conventional single-user matched filter, which adopts the p(t−τ₁−mT_{f}) as the correlation waveform for the mth frame, is used to coherently detect the signal to be recovered, the correlator output is

$$\begin{matrix}r = {\sum }_{m = 0}^{{N}_{s} - 1} {\int }_{{mT}_{f} + {τ}_{1}}^{( m + 1 ) {T}_{f} + {τ}_{1}} r ( t ) p ( t - {τ}_{1} - {mT}_{f} ) d t \\ = S + I + N\end{matrix} \qquad ( 3 )$$

where m is the frame index of the information bit to be recovered, and S=A₁\sqrt{E_{b}Nₛd₀⁽¹⁾} is desired signal component where d₀⁽¹⁾ is the information bit transmitted by the desired user. The RV N is Gaussian distributed with zero mean and variance N₀Nₛ/2. The parameter I, which represents the total MAI originating from all Nₛ frames, can be written as

$$I = \sqrt{\frac{{E}_{b}}{{N}_{s}}} {\sum }_{k = 2}^{{N}_{u}} {A}_{k} {I}^{( k )} \qquad ( 4 )$$

where I^{(k)} can be expressed as

$${I}^{( k )} = {\sum }_{m = 0}^{{N}_{s} - 1} {\int }_{{mT}_{f} + {τ}_{1}}^{( m + 1 ) {T}_{f} + {τ}_{1}} {s}^{( k )} ( t - {τ}_{k} ) p ( t - {τ}_{1} - {mT}_{f} ) d t . \qquad ( 5 )$$

Substituting (1) into (5) and denoting the autocorrelation function of the UWB pulse waveform p(t) as

$$R ( x ) = {\int }_{- ∞}^{+ ∞} p ( t - x ) p ( t ) d t ,$$

I^{(k)} can be rewritten as

$${I}^{( k )} = {\sum }_{m = 0}^{{N}_{s} - 1} {\sum }_{j = - ∞}^{+ ∞} {d}_{⌊ j / {N}_{s} ⌋}^{( k )} R ( {τ}_{s}^{( k )} + {mT}_{f} - {jT}_{f} - {c}_{j}^{( k )} {T}_{c} ) \qquad ( 6 )$$

where τₛ^{(k)} is the time shift difference between different users which can be modeled in the same way as in M. Z. Win and R. A. Scholtz, “Ultra-Wide Bandwidth Time-Hopping Spread-Spectrum Impulse Radio for wireless Multiple-Access Communications,” IEEE Trans. Commun., vol. 48, pp. 679-691, April 2000, namely

τₛ^{(k)}=τ₁−τₖ=mₖT_{f}αₖ (7)

where mₖ is the value of the time uncertainty rounded to the nearest integer, and αₖ is the fractional part which is uniformly distributed in the region (−T_{f}/2,T_{f}/2]. Then the argument of (R·) is

(m+mₖ−j)T_{f}−cⱼ^{(k)}T_{c}+αₖ. (8)

Based on the assumption NₕT_{c}<T_{f}/2−2Tₚ, which means that the pulse can only hop over an interval of one-half of a frame time, Eq. (6) can be rewritten as

$${I}^{( k )} = {\sum }_{m = 0}^{{N}_{s} - 1} {\sum }_{j = - ∞}^{+ ∞} {d}_{⌊ ( m + {m}_{k} ) / {N}_{s} ⌋}^{( k )} R ( {α}_{k} - {c}_{m + {m}_{k}}^{( k )} {T}_{c} ) . \qquad ( 9 )$$

Putting (9) back into (4) and rearranging the order of summation, the total interference term can be represented in terms of the interference originating from a single frame, Iₘ, as

$${I}^{( k )} = \sqrt{\frac{{E}_{b}}{{N}_{s}}} {\sum }_{k = 2}^{{N}_{u}} {A}_{k} {\sum }_{m = 0}^{{N}_{s} - 1} {d}_{⌊ ( m + {m}_{k} ) / {N}_{s} ⌋}^{( k )} R ( {α}_{k} - {c}_{m + {m}_{k}}^{( k )} {T}_{c} ) \\ = {\sum }_{m = 0}^{{N}_{s} - 1} {\sum }_{k = 2}^{{N}_{u}} {A}_{k} \sqrt{\frac{{E}_{b}}{{N}_{s}}} {d}_{⌊ ( m + {m}_{k} ) / {N}_{s} ⌋}^{( k )} R ( {α}_{k} - {c}_{m + {m}_{k}}^{( k )} {T}_{c} ) \\ = {\sum }_{m = 0}^{{N}_{s} - 1} {I}_{m} \qquad ( 10 )$$

where Iₘ is given by

$${I}_{m} = {\sum }_{k = 2}^{{N}_{u}} {A}_{k} \sqrt{\frac{{E}_{b}}{{N}_{s}}} {d}_{⌊ ( m + {m}_{k} ) / {N}_{s} ⌋}^{( k )} R ( {α}_{k} - {c}_{m + {m}_{k}}^{( k )} {T}_{c} ) . \qquad ( 11 )$$

Then the final receiver decision statistic can be expressed as a summation of statistics in each frame

$$r = {\sum }_{m = 0}^{{N}_{s} - 1} {r}_{m} = {\sum }_{m = 0}^{{N}_{s} - 1} ( {S}_{m} + {I}_{m} + {N}_{m} ) \\ = {\sum }_{m = 0}^{{N}_{s} - 1} ( {S}_{m} + {Y}_{m} ) \qquad ( 12 )$$

where Sₘ=A₁\sqrt{E_{b}/Nₛd₀⁽¹⁾} is the desired signal component in the mth frame, Nₘ is a Gaussian distributed RV with variance N₀/2, and Iₘ is the total interference component in the mth frame from all interferers given in (11). The RV Yₘ is the overall disturbance (MAI plus AWGN) in the mth frame.

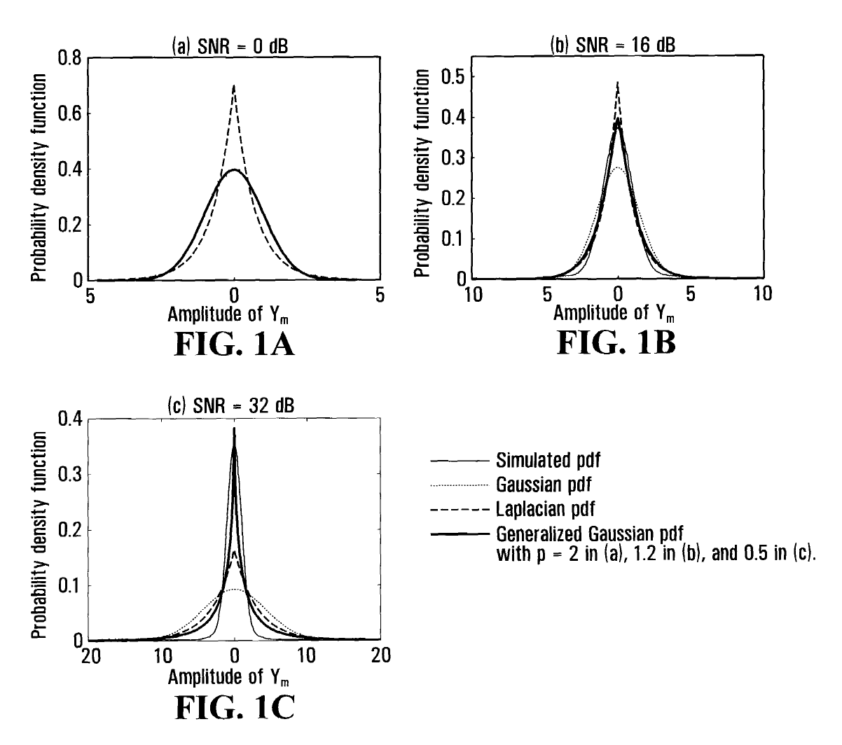

The conventional matched filter is the optimal receiver structure when a signal is corrupted by AWGN, while the soft-limiting UWB receiver is optimal for a signal embedded in additive Laplace noise. FIG. 1 shows an example of the form of the probability density function (pdf) of the overall disturbance in a single frame Yₘ, f_{Y}_{ₘ}(x), with SIR=10 dB and different SNR values. These results are obtained by simulation. It is noted that the overall disturbance in a single frame Yₘ can not be simply described as a Gaussian RV or a Laplacian RV, which means that neither the conventional matched filter UWB receiver nor the soft-limiting UWB receiver is the optimal receiver for UWB communication systems. If an optimal receiver is to be designed for UWB communication systems, the pdf of the RV Yₘ should be characterized mathematically and the optimal receiver can be derived rigorously using ML receiver design principles. Characterizing mathematically the pdf of Yₘ in FIG. 1 seems difficult, especially when the SNR is small and the MAI dominates the AWGN. An approximation of the pdf of Yₘ which is better than the Gaussian approximation (GA) and Laplacian approximation (LA) is provided, and an optimal UWB receiver based on the new approximated pdf is provided.

Observe in FIG. 1 that when the SNR is small, i.e. the AWGN dominates the MAI, the overall disturbance in a single frame Yₘ can be approximated as a Gaussian RV. In this case, the conventional matched filter UWB receiver works almost as an optimal receiver in the UWB communications systems. As the SNR grows larger, the MAI term Iₘ becomes more and more significant in Yₘ=Nₘ+Iₘ, and the pdf of the Laplacian distribution fits the pdf of Yₘ better than the pdf of Gaussian distribution. That is why the soft-limiting UWB receiver, which is the optimal structure for a signal embedded in additive Laplace noise, outperforms the conventional matched filter UWB receiver even though the overall disturbance Yₘ in this SNR region is not exactly Laplacian distributed. When the SNR is large enough that the MAI dominates the AWGN, it is shown by FIG. 1C that both the GA and LA are not good approximations in this SNR region, although the Laplacian pdf is better than the Gaussian pdf.

Note that the pdf of a Gaussian distributed RV is

$${f}_{g} ( x ) = \frac{1}{\sqrt{2 {πσ}^{2}}} exp \{ - \frac{{( x - {S}_{m} )}^{2}}{2 {σ}^{2}} \} \qquad ( 13 )$$

where Sₘ and σ are the mean and the standard deviation of the RV, respectively. The pdf of a Laplacian distributed RV is

$${f}_{l} ( x ) = \frac{1}{2 b} exp \{ - \frac{\vert x - {S}_{m} \vert}{b} \} \qquad ( 14 )$$

where the mean of the RV is Sₘ and the variance is 2b². Observe that both pdfs have the form f(x)=c·exp{−γ|x−Sₘ|^{p}}, while the pdf of a Gaussian RV is with p=2 and the pdf of a Laplacian RV is with p=1. A new form of approximation for the pdf of Yₘ is provided as

f(x)=c·exp{−γ|x−Sₘ|^{p}} (15)

where the parameter p is adaptive. The adaptation rate is implementation specific. It may be adapted, for example, every transmission. In the above, c is a constant to ensure that

$${\int }_{- ∞}^{+ ∞} f ( x ) d x = 1.$$

The parameter γ is used to adjust the second moment of the RV to some certain value. For example, the parameter might be selected according to:

$$γ = {[ \frac{{σ}^{2} Γ ( 1 \text{/} p )}{Γ ( 3 \text{/} p )} ]}^{- 1 / 2} , \qquad ( 15 a )$$

where σ² is the variance of the RV, p is the shape parameter, and Γ(·) is the Gamma function. However, this parameter γ will not affect the structure of the UWB receiver as shown below. Different values of p are selected adaptively to fit the pdf of Yₘ for different SNRs. Within the region where the SNR is small and the RV Yₘ is approximately Gaussian distributed, f(x) can be used to approximate the pdf of Yₘ by setting p to 2, while in the region where the SNR values are moderate and the pdf can be approximated by pdf of the Laplace distribution, f(x) with p=1 becomes a good approximation of the pdf of the RV Yₘ. Note that the new approximated pdf f(x) changes in the same manner with the decreasing p as the pdf of Yₘ changes with the increasing values of the SNR. When the SNR grows large enough that neither the GA nor the LA is a good approximation of the pdf of Yₘ, f(x) with p less than 1 fits the actual pdf of Yₘ better than the Gaussian and Laplacian pdfs as shown in FIG. 1C. Based on this observation, an optimal receiver structure can be derived based on the assumption that the pdf of the overall disturbance in a single frame, Yₘ, can be approximated as a RV with pdf f(x). Consider the simple hypothesis test in a single chip of the following form:

H₀:=rₘ=Sₘ+Yₘ

H₁:=rₘ=−Sₘ+Yₘ m=0, . . . , Nₛ−1 (16)

where rₘ is the chip correlator output, Nₛ denotes the number of chips to transmit one single information bit, Sₘ is the sampled signal value in a single frame, {Yₘ}ₘ₌₁^{N}^{ₛ} are i.i.d RVs which represent the samples of the overall disturbance in each chip, which could be AWGN or AWGN-plus-MAI. The RV Yₘ can be assumed to have zero mean without loss of generality, since if it is not the case, a non-zero parameter can be subtracted from each rₘ and the problem can be reformulated as in (16).

Note that the function f(x) has the same form as the pdf of the generalized Gaussian distribution defined in S. M. Kay, Fundamentals of Statistical Signal Processing: Detection Theory, Englewood Cliffs: Prentice Hall 1998,

$${f}_{gg} ( x ; {S}_{m} , σ , p ) = \frac{1}{2 Γ ( 1 + 1 \text{/} p ) A ( p , σ )} {e}^{- {\vert \frac{x - {S}_{m}}{A ( p , σ )} \vert}^{p}} \qquad ( 15 b )$$

where the parameter Sₘ is the mean of the RV, the function

$$A ( p , σ ) = {[ \frac{{σ}^{2} Γ ( 1 \text{/} p )}{Γ ( 3 \text{/} p )} ]}^{1 / 2}$$

is a scaling factor which ensures that var(x)=σ²,Γ(·) is the Gamma function, and p is the shape parameter. Observe that the pdfs of the Gaussian and Laplacian distributions are special cases of the generalized Gaussian distribution, the Gaussian pdf having p=2 and the Laplacian pdf having p=1.

Based on this observation, an optimal receiver structure is provided that is based on the assumption that the pdf of the overall disturbance in a single frame, Yₘ, can be approximated as a RV with pdf f(x). In the optimal detector, the transformation of the single chip correlator output, rₘ, to the single sample log-likelihood ratio Lₘ(rₘ), is given by (See H. L. Van Trees, Detection, Estimation, and Modulation Theory, Part I. New York: Wiley, 2001)

$${h}_{m} ( {r}_{m} ) = log {L}_{m} ( {r}_{m} ) \\ = log \{ \frac{f ( {r}_{m} \vert {d}_{0}^{( 1 )} = 1 )}{f ( {r}_{m} \vert {d}_{0}^{( 1 )} = - 1 )} \} \qquad ( 17 )$$

Eq. (17) defines a transform of the chip correlator output, rₘ, into a partial decision statistic, hₘ(rₘ). If the new approximation (15) of the pdf is adopted, the new partial decision statistic, hₘ(rₘ), is given by

$${h}_{m} ( {r}_{m} ) = log \{ \frac{f ( {r}_{m} \vert {d}_{0}^{( 1 )} = 1 )}{f ( {r}_{m} \vert {d}_{0}^{( 1 )} = - 1 )} \} \\ = γ {\vert {r}_{m} + {S}_{m} \vert}^{p} - γ {\vert {r}_{m} - {S}_{m} \vert}^{p} \qquad ( 18 )$$

where γ can be chosen to be 1 or other positive real values. The final decision statistic of the detector is represented as

$$\tilde{r} = {\sum }_{m = 0}^{{N}_{s} - 1} {h}_{m} ( {r}_{m} ) . \qquad ( 19 )$$

The transmitted information bit d₀⁽¹⁾ is detected based on the new decision statistic \tilde{r} according to the rule

\tilde{r}>0=>d₀⁽¹⁾=+1 (20a)

\tilde{r}<0=>d₀⁽¹⁾=−1 (20b)

If \tilde{r}=0, a fair coin maybe tossed to decide which information bit was transmitted, or d₀⁽¹⁾=1 can be decided, or d₀⁽¹⁾=−1 can be decided.
If p=2, eq. (18) becomes

$${h}_{m} ( {r}_{m} ) = γ {\vert {r}_{m} - {S}_{m} \vert}^{2} - γ {\vert {r}_{m} - {S}_{m} \vert}^{2} \\ = 4 γ {r}_{m} {s}_{m} \qquad ( 21 )$$

and the final decision statistic \tilde{r} becomes

$$\tilde{r} = {\sum }_{m = 0}^{{N}_{s} - 1} {h}_{m} ( {r}_{m} ) \\ = 4 γ {r}_{m} {s}_{m} \qquad ( 22 )$$

and the p-omr becomes exactly the same as the conventional matched filter UWB receiver. If p assumes the value of 1, eq. (18) becomes

$$\begin{matrix}{h}_{m} ( {r}_{m} ) = γ \vert {r}_{m} - {S}_{m} \vert - γ \vert {r}_{m} + {S}_{m} \vert \\ = \{ \begin{matrix}2 γ {S}_{m} & if {r}_{m} \geq {S}_{m} \\ 2 γ {r}_{m} & if - {S}_{m} < {r}_{m} < {S}_{m} \\ - 2 γ {S}_{m} & if {r}_{m} \leq - {S}_{m}\end{matrix}\end{matrix} \qquad ( 23 )$$

and the p-omr becomes the same as the soft-limiting receiver.

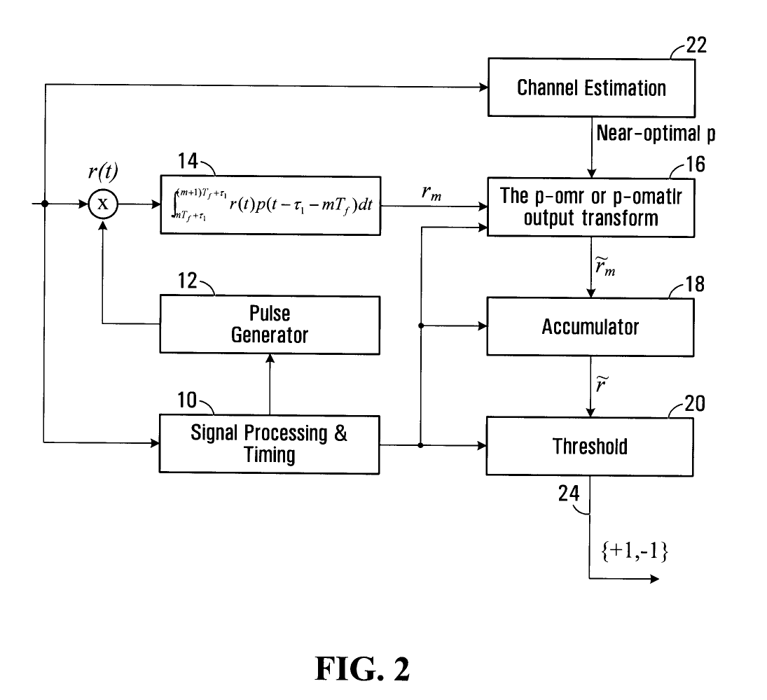

Referring now to FIG. 2, shown is a block diagram of a receiver provided by an embodiment of the invention that can be used to implement the above-described approach. In FIG. 2, the receiver has a signal processing and timing function 10 and pulse generator 12. The output of the pulse generator is multiplied by a received signal r(t) and the result input to correlator 14. The output of the correlator 14 is input to a p-omr or p-omatlr (p-order metric adaptive threshold limiter) output transform 16. If the receiver has a fixed threshold limiter, it is the p-omr receiver; if it has an adaptive threshold limiter it is the p-omatlr receiver (described below). The p-omr or p-omatlr output transform 16 produces the partial statistics \tilde{r}ₘ, that are passed to an accumulator 18 where they are accumulated to produce the overall decision statistic \tilde{r}. This is then processed by threshold function 20 to produce an output 24. The p-omr or p-omatlr output transform 16, accumulator 18, and threshold function 20 are also operatively coupled to the signal processing and timing function 10. The received signal r(t) is also passed to channel estimation element 22 which produces a near optimal p that is passed to the p-omr or p-omatlr output transform 16. Details of an example method of determining p are given below. The components of the receiver of FIG. 2 may be implemented as software running on an appropriate platform, hardware, firmware or combinations of software, hardware and firmware. In some embodiments, additional components, such as one or more antennas (not shown) are included.

In operation a received signal r(t) is processed by signal processing and timing function 10 to recover timing. As a function of this timing, the pulse generator 12 generates a pulse for use by correlator 14 in performing a correlation between the pulse and r(t). The output of the correlator rₘ is passed to the p-omr or p-omatlr output transform 16 where it is transformed as described in detail to produce the partial statistic \tilde{r}ₘ, where \tilde{r}ₘ=hₘ(rₘ) as defined in equation (18). The \tilde{r}ₘ's relating to the same bit are summed in the accumulator 18 to produce \tilde{r} (this is equivalent to equation (19)), and a final decision on the sum is made by the threshold function 20.

It is emphasized that the design of the p-omr and p-omatlr structure is based on an approximation of the true pdf. That is, the p-omr and p-omatlr are not optimal. However, the discussion above shows that the p-omr becomes exactly the same as the conventional matched filter UWB receiver or the soft-limiting UWB receiver for certain values of p, which implies that if the parameter p is adaptive and optimized, the p-omr can always meet or outperform both the conventional matched filter UWB receiver and the soft-limiting UWB receiver. Meanwhile, the p-omatlr becomes exactly the same as the conventional matched filter UWB receiver or the adaptive threshold soft-limiting receiver for certain values of p and threshold Tₒₚₜ, which implies that if the parameter p and the threshold Tₒₚₜ are both adaptive and optimized, the p-omatlr can always meet or outperform both the conventional matched filter UWB receiver and the adaptive threshold soft-limiting UWB receiver.

### Estimation of the Shape Parameter p

In order to implement the p-omr for signal detection, the shape parameter p in the pdf f(x) of equation (15) needs to be estimated. Equivalently, the shape parameter for the generalized Gaussian pdf of equation (15b) can be estimated, and it is this form of the pdf that will be used in the analysis that follows. In FIG. 2, p is determined in the channel estimation block 22. A specific method of estimating a near optimal p will now be described. Note that the odd central moments of a RV X with pdf f_{gg}(x) are all zero, while the even central moments of X are given by

$$E ( {X}^{n} ) = {[ \frac{{σ}^{2} Γ ( 1 / p )}{Γ ( 3 / p )} ]}^{n / 2} \frac{Γ ( ( n + 1 ) / p )}{Γ ( 1 / p )} . \qquad ( 24 )$$

The kurtosis of RV X with pdf f_{gg}(x) can be expressed as

$${K}_{m} ( p ) = \frac{E ( {X}^{4} )}{{E}^{2} ( {X}^{2} )} - 3 = \frac{Γ ( 1 / p ) Γ ( 5 / p )}{{Γ}^{2} ( 3 / p )} - 3. \qquad ( 25 )$$

Note that, shape parameter p is the only argument in eq. (25), and as a function of p, the kurtosis is monotonically decreasing. Thus, it is easy to obtain the shape parameter p once the kurtosis is determined. In some embodiments, the shape parameter p can be estimated from an estimated value for the kurtosis.

Note that in eq. (11), the total interference in the mth frame can be expressed as

$$\begin{matrix}\begin{matrix}{I}_{m} = {\sum }_{k = 2}^{{N}_{u}} \sqrt{\frac{{E}_{b}}{{N}_{s}}} {A}_{k} {d}_{⌊ ( m + {m}_{k} ) / {N}_{s} ⌋}^{( k )} R ( {α}_{k} - {c}_{m + {m}_{k}}^{( k )} {T}_{c} ) \\ = {\sum }_{k = 2}^{{N}_{u}} \sqrt{\frac{{E}_{b}}{{N}_{s}}} {A}_{k} {I}_{( m , k )}\end{matrix} \\ where & ( 26 ) \\ {I}_{( m , k )} = {d}_{⌊ ( m + {m}_{k} ) / {N}_{s} ⌋}^{( k )} ( {α}_{k} - {c}_{m + {m}_{k}}^{( k )} {T}_{c} ) & ( 27 )\end{matrix}$$

is the interference in the mth frame from the kth user. Note that mₖ is the value of the time shift difference between the desired user and the kth user, τₛ^{(k)}=τ₁−τₖ, measured in durations of one frame time rounded to the nearest integer, and αₖ is the fractional part which is uniformly distributed in

$$[ - \frac{{T}_{f}}{2} , \frac{{T}_{f}}{2} ) .$$

According to the assumption that the TH sequences are random, the pdf of cₘ₊ₘ_{ₖ}^{(k)} conditioned on d_{└(m+m}_{ₖ}_{)/N}_{ₛ}_{┘}^{(k)} and τₛ^{(k)} (represented by mₖ, αₖ in the formula) is

$${f}_{{c}_{m + {m}_{k}}^{( k )} \vert {d}_{⌊ ( m + {m}_{k} ) / {N}_{s} ⌋}^{( k )} , {m}_{k} , {α}_{k}} ( c ) = \frac{1}{{N}_{h}} {\sum }_{h = 0}^{{N}_{h} - 1} δ ( c - {hT}_{c} ) \qquad ( 28 )$$

where δ(·) is the Dirac delta function. Then, the characteristic function (CF) of I_{(m,k)} conditioned on d_{└(m+m}_{ₖ}_{)/N}_{ₛ}_{┘}^{(k)}, mₖ, and αₖ is

$${Φ}_{I ( m , k ) \vert {m}_{k} , {α}_{k} , {d}_{⌊ ( m + {m}_{k} ) / {N}_{s} ⌋}^{( k )}} ( w ) = \frac{1}{{N}_{h}} {\sum }_{h = 0}^{{N}_{h}} [ {e}^{j {wd}_{⌊ ( m + {m}_{k} ) / {N}_{s} ⌋}^{( k )} R ( {α}_{k} - {hT}_{c} )} ] \qquad ( 29 )$$

The conditional CF of I_{(m,k)} can be further expressed using the theorem of total probability as

$${Φ}_{{I}_{( m , k )} \vert {m}_{k} , {α}_{k}} ( ω ) = {Φ}_{{I}_{( m , k )} \vert {m}_{k} , {α}_{k} , {d}_{⌊ {l}_{k} / {N}_{s} ⌋}^{( k )} = 1} ( ω ) \cdot {P}_{r} ( {d}_{⌊ {l}_{k} / {N}_{s} ⌋}^{( k )} = 1 ) + {Φ}_{{I}_{( m , k )} \vert {m}_{k} , {α}_{k} , {d}_{⌊ {l}_{k} / {N}_{s} ⌋}^{( k )} = - 1} ( ω ) \cdot {P}_{r} ( {d}_{⌊ {l}_{k} / {N}_{s} ⌋}^{( k )} = - 1 ) \qquad ( 30 )$$

where lₖ=m+mₖ. Assuming the interfering symbol d_{└I}_{ₖ}_{/N}_{ₛ}_{┘}^{(k)} takes values from {+1,−1} with equal probabilities for a given τₛ^{(k)} when mₖ and αₖ are fixed, the CF of I_{(m,k)} is

$$\begin{matrix}{Φ}_{{I}_{( m , k )} \vert {m}_{k} , {α}_{k}} ( ω ) = \frac{1}{{N}_{h}} {\sum }_{h = 0}^{{N}_{h} - 1} \{ \frac{1}{2} E [ {e}^{j ω R ( {α}_{k} - {hT}_{c} )} + {e}^{- j ω R ( {α}_{k} - {hT}_{c} )} ] \} \\ = \frac{1}{{N}_{h}} {\sum }_{h = 0}^{{N}_{h} - 1} \{ \frac{1}{2} E [ cos ( ω \cdot R ( {α}_{k} - {hT}_{c} ) ) ] \} \\ = {Φ}_{{I}_{( m , k )} \vert {α}_{k}} ( ω )\end{matrix} \qquad ( 31 )$$

The fraction part of the time shift difference, αₖ, is assumed to be uniformly distributed in

$$[ - \frac{{T}_{f}}{2} , \frac{{T}_{f}}{2} )$$

as mentioned before, thus, the CF of I_{(m,k)} can be represented as

$$\begin{matrix}{Φ}_{{I}_{( m , k )}} ( ω ) = {\int }_{{α}_{k}}^{ } {Φ}_{{I}_{( m , k )} {α}_{k}} {f}_{{α}_{k}} ( {α}_{k} ) d {α}_{k} \\ = \frac{1}{{T}_{f} {N}_{h}} {\sum }_{h = 0}^{Nh - 1} {\int }_{- Tf / 2}^{Tf / 2} cos ( ω \cdot R ( {α}_{k} - {hT}_{c} ) ) d {α}_{k} .\end{matrix} \qquad ( 32 )$$

The nth derivative of the CF Φₓ(ω) evaluated at ω=0 yields the nth moment of the RV X

$$E ( {X}^{n} ) = {( - j )}^{n} \frac{{d}^{n} {Φ}_{X} ( w )}{d {w}^{n}} \vert w = 0. \qquad ( 33 )$$

Thus, when n is odd, the nth moment of the interference term, I_{(m,k)}, is

$$\begin{matrix}E ( {I}_{( m , k )}^{n} ) = \frac{{( - j )}^{n} {( - 1 )}^{\frac{n + 1}{2}}}{{T}_{f} {N}_{h}} \cdot \\ {\sum }_{h = 0}^{{N}_{h} - 1} {\int }_{- {T}_{f} / 2}^{{T}_{f} / 2} {R}^{n} ( {α}_{k} - {hT}_{c} ) \cdot sin ( ω R ( {α}_{k} - {hT}_{c} ) ) d {α}_{k} \\ = 0\end{matrix} \qquad ( 34 )$$

and when n is even, the nth moment can be expressed as

$$\begin{matrix}E ( {I}_{( m , k )}^{n} ) = \frac{{( - 1 )}^{\frac{n}{2}} {( - j )}^{n}}{{T}_{f} {N}_{h}} \cdot \\ {\sum }_{h = 0}^{{N}_{h} - 1} {\int }_{- {T}_{f} / 2}^{{T}_{f} / 2} {R}^{n} ( {α}_{k} - {hT}_{c} ) \cdot cos ( ω R ( {α}_{k} - {hT}_{c} ) ) d {α}_{k} {\vert}_{ω = 0} \\ = \frac{{( - 1 )}^{\frac{n}{2}} {( - j )}^{n}}{{T}_{f} {N}_{h}} {\sum }_{h = 0}^{{N}_{h} - 1} {\int }_{- {T}_{f} / 2}^{{T}_{f} / 2} {R}^{n} ( {α}_{k} - {hT}_{c} ) d {α}_{k} .\end{matrix} \qquad ( 35 )$$

The first and third moments of I_{(m,k)} are both 0, while the second and fourth moments are

$$\begin{matrix}E ( {I}_{( m , k )}^{2} ) = \frac{1}{{T}_{f} {N}_{h}} \cdot {\sum }_{h = 0}^{{N}_{h} - 1} {\int }_{- {T}_{f} / 2}^{{T}_{f} / 2} {R}^{2} ( {α}_{k} - {hT}_{c} ) d {α}_{k} \\ and & ( 36 a ) \\ E ( {I}_{( m , k )}^{4} ) = \frac{1}{{T}_{f} {N}_{h}} \cdot {\sum }_{h = 0}^{{N}_{h} - 1} {\int }_{- {T}_{f} / 2}^{{T}_{f} / 2} {R}^{4} ( {α}_{k} - {hT}_{c} ) d {α}_{k} & ( 36 b )\end{matrix}$$

respectively.

Note that the duration of the UWB pulse p(t) is τₚ, thus, the support of the autocorrelation function R(x) is [−τₚ,τₚ). Letting x=αₖ−hT_{c}, the term for a particular value of h in eq. (36a) can be rewritten as

$${\int }_{- {T}_{f} / 2}^{{T}_{f} / 2} {R}^{2} ( {α}_{k} - {hT}_{c} ) d {α}_{k} = {\int }_{- {T}_{f} / 2 - {hT}_{c}}^{{T}_{f} / 2 - {hT}_{c}} {R}^{2} ( x ) d x . \qquad ( 37 )$$

With the assumption NₕT_{c}<T_{f}/2−2τₚ, the region of the integration at the right side of eq. (37) is an interval covering the support of the integrand. Thus, the integration region can be extended to (−∞, +∞) without changing the integral, and the term for a particular h can be rewritten as

$${\int }_{- ∞}^{+ ∞} {R}^{2} ( x ) d x .$$

Note that these terms for all the possible values of h are the same. Thus, eq. (36a) can be expressed as

$$\begin{matrix}E ( {I}_{( m , k )}^{2} ) = \frac{1}{{N}_{h} {T}_{f}} {\sum }_{h = 0}^{{N}_{h} - 1} {\int }_{- {T}_{f} / 2}^{{T}_{f} / 2} {R}^{2} ( {α}_{k} - {hT}_{c} ) d {α}_{k} \\ = \frac{1}{{N}_{h } {T}_{f}} {\sum }_{h = 0}^{{N}_{h} - 1} {\int }_{- ∞}^{∞} {R}^{2} ( x ) d x \\ = \frac{1}{{T}_{f}} {\int }_{- ∞}^{∞} {R}^{2} ( x ) d x\end{matrix} \qquad ( 38 )$$

Note that eq. (38) represents the variance of the MAI from a single user in a single frame. Eq. (36b) can be simplified as

$$\begin{matrix}E ( {I}_{( m , k )}^{4} ) = \frac{1}{{N}_{h} {T}_{f}} {\sum }_{h = 0}^{{N}_{h} - 1} {\int }_{- {T}_{f} / 2}^{{T}_{f} / 2} {R}^{4} ( {α}_{k} - {hT}_{c} ) d {α}_{k} \\ = \frac{1}{{T}_{f}} {\int }_{- ∞}^{∞} {R}^{4} ( x ) d x\end{matrix} \qquad ( 39 )$$

According to eq. (26), the first moment and the third moment of the total disturbance in the mth frame are 0. If equal power interferers are considered and it is assumed that the interference from different interferers are independent, the second moment of Iₘ can be written as

$$E ( {I}_{m}^{2} ) = E ( {I}_{( m , k )}^{2} ) \frac{{E}_{b}}{{N}_{s}} {\sum }_{k = 2}^{{N}_{u}} {A}_{k}^{2} = \frac{{E}_{b} ( {N}_{u} - 1 )}{{N}_{s}} {A}_{k}^{2} \cdot E ( {I}_{( m , k )}^{2} ) . \qquad ( 40 )$$

The fourth moment of the RV Iₘ is

$$\begin{matrix}E ( {I}_{m}^{4} ) = E [ {( {\sum }_{k = 2}^{{N}_{u}} \sqrt{\frac{{E}_{b}}{{N}_{s}}} {A}_{k} {I}_{( m , k )} )}^{4} ] \\ = {( \frac{{E}_{b}}{{N}_{s}} )}^{2} {A}_{k}^{4} \{ E [ {( {\sum }_{k = 2}^{{N}_{u}} {I}_{( m , k )} )}^{4} ] \} \\ = {( \frac{{E}_{b}}{{N}_{s}} )}^{2} {A}_{k}^{4} [ ( {N}_{u} - 1 ) E ( {I}_{( m , k )}^{4} ) + 6 ( \begin{matrix}{N}_{u} - 1 \\ 2\end{matrix} ) {E}^{2} ( {I}_{( m , k )}^{2} ) ] .\end{matrix} \qquad ( 41 )$$

When both MAI and AWGN are present in the channel, the GGA is used to model the total disturbance term Yₘ=Iₘ+Nₘ. Assuming that the AWGN term and the MAI term both have zero means and are independent, the mean of the total disturbance term Yₘ=Iₘ+Nₘ is also zero, and its variance can be written as

E(Yₘ²)=E(Iₘ²)+E(Nₘ²) (42)

The fourth central moment of the RV Yₘ is

E(Yₘ⁴)=E(Iₘ⁴)+6E(Iₘ²)E(Nₘ²)+E(Nₘ⁴) (43)

The kurtosis of the RV Yₘ can be represented as

$$\begin{matrix}K ( {Y}_{m} ) = \frac{E ( {Y}_{m}^{4} )}{{E}^{2} ( {Y}_{m}^{2} )} - 3 \\ = \frac{E ( {I}_{m}^{4} ) + 6 E ( {I}_{m}^{2} ) E ( {N}_{m}^{2} ) + E ( {N}_{m}^{4} )}{{[ E ( {I}_{m}^{2} ) + E ( {N}_{m}^{2} ) ]}^{2}} - 3\end{matrix} \qquad ( 44 )$$

where E(Iₘ²) and E(Iₘ⁴) are the second and fourth moments of Iₘ given by (40) and (41), respectively, and E(Nₘ²)=σₙ² and E(Nₘ⁴)=3σₙ⁴ are the variance and the fourth moment of the AWGN component in the mth frame. The shape parameter p in this case can be estimated by matching eq. (44) and (25), and the estimated value for the shape parameter, \hat{p}, satisfies

$$\frac{Γ ( 1 / \hat{p} ) Γ ( 5 / \hat{p} )}{{Γ}^{2} ( 3 / \hat{p} )} = \frac{E ( {I}_{m}^{4} ) + 6 E ( {I}_{m}^{2} ) E ( {N}_{m}^{2} ) + E ( {N}_{m}^{4} )}{{[ E ( {I}_{m}^{2} ) + E ( {N}_{m}^{2} ) ]}^{2}} \qquad ( 45 )$$

In some embodiments, a table look-up mechanism is implemented that maps channel estimates for Iₘ,Nₘ to the solution of equation 45. Alternatively, the solution to equation (45) or an approximation thereto can be implemented in hardware or software.

A very specific method of determining p based on kurtosis matching has been described. Other methods can be employed; for example, a computer search to determine values of p for respective sets of channel conditions may be employed. The results can be used to implement a table look-up mechanism. Interpolation may be employed to determine p for channel conditions not specifically covered.

In some embodiments, adapting p involves: measuring a channel condition; updating p as a function of the channel condition.

In some embodiments, adapting p involves: maintaining a table lookup of p as a function of a channel condition; updating p by measuring the channel condition, and looking up the new value for p using the table lookup.

### P-Order Metric Adaptive Threshold Limiting Receiver

The soft-limiting UWB receiver N. C. Beaulieu and B. Hu, “A soft-limiting receiver structure for time-hopping UWB in multiple access interference,” in Proc. IEEE International Symposium on Spread Spectrum Techniques and Application (ISSSTA 2006), September 2006, pp. 417-421 underperforms the CMF UWB receiver in practical mixed MAI-plus-AWGN environments for small to moderate values of SNR. The adaptive threshold soft-limiting UWB receiver in N. C. Beaulieu and B. Hu, “An adaptive threshold soft-limiting UWB Receiver with improved performance in multiuser interference”, in Proc. IEEE International Conference on Ultra-Wideband (ICUWB 2006), September 2006, pp. 405-410 based on the soft-limiting UWB receiver achieves better performance and outperforms the CMF UWB receiver for all the SNR values in such environments by adopting an adaptive limiter threshold Tₒₚₜ instead of Sₘ. In similar fashion, an extra degree of freedom Tₒₚₜ can also be introduced to the p-omr. That is, as in eq. (18),

hₘ(rₘ)=γ|rₘ+Tₒₚₜ|^{p}−γ|rₘ−Tₒₚₜ|^{p} (46)

where p can, for example, be determined by the kurtosis matching method described above, and the threshold Tₒₚₜ is adaptive and optimized to gain the best BER performance. The parameter γ can be chosen to be 1 or other positive real values. Note that when p=1 and Tₒₚₜ is adaptive, the receiver becomes exactly the adaptive threshold soft-limiting UWB receiver. Theoretically, if the shape parameter p is estimated and threshold Tₒₚₜ are optimized to minimize the BER, the new receiver referred to herein as the “p-order metric adaptive threshold limiting receiver” (p-omatlr) must always meet or outperform the CMF UWB receiver, the adaptive threshold soft-limiting UWB receiver, and the p-omr. This will be true for arbitrary additive signal disturbances, including MAI, AWGN, and MAI-plus-AWGN.

In some embodiments, bit error monitoring at the bit level or the packet level is performed, or table look-up using channel state conditions measurement is performed, and a mapping transformation between SNR, SIR and or SINR to \hat{p}, Tₒₚₜ, σₙ², σₙ⁴ and BER is used to determine the shaping parameter and the optimal adaptive threshold.

### Multipath Fading Channels

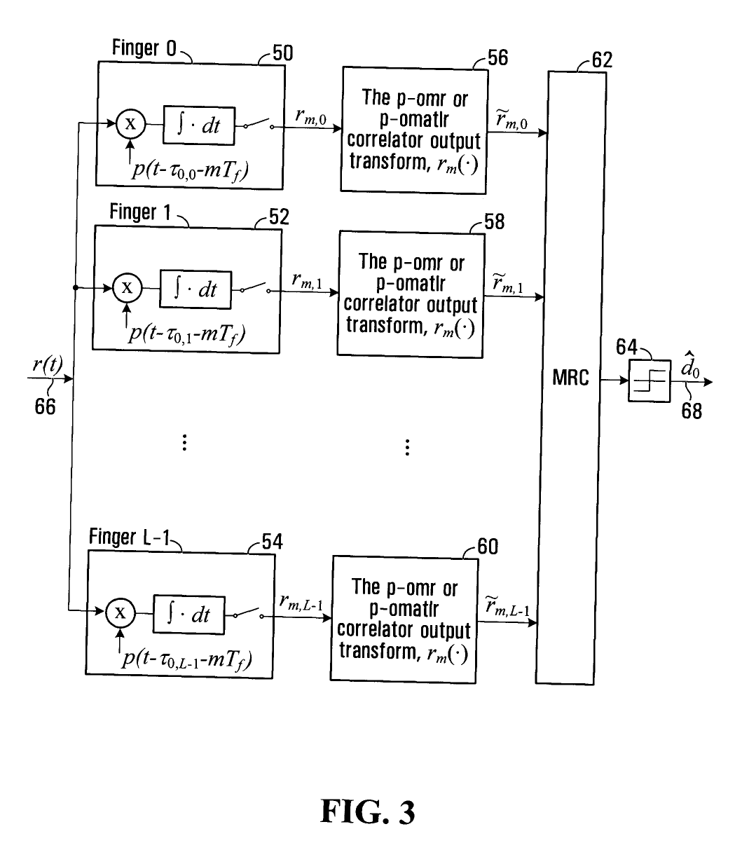

The previous embodiments have considered an AWGN channel model. Now a more practical scenario, the multipath fading channel is considered. Although many multipath components are present in UWB systems, the total disturbance is not always Gaussian. Even if the total disturbance is Gaussian distributed, this may not be the case for the chip correlator output in each Rake finger. This is why the superiority of the p-omr and p-omatlr designs still exists even in highly dense multipath UWB channels as subsequent results will show. Note that the robustness of UWB signals to multipath fading is due to their fine delay resolution, and high diversity order can be achieved with the adoption of a Rake receiver in UWB systems. It has already been shown that the p-omr and p-omatlr can achieve better BER performance in ideal free-space propagation (AWGN) channels. A new Rake receiver adopting the p-omr or p-omatlr in each finger is provided for signal detection. This new Rake receiver can achieve larger SINR than the standard matched filter based Rake receiver. FIG. 3 is a block diagram of this new Rake receiver provided by an embodiment of the invention. For the purpose of this example, it is assumed the Rake receiver performs maximal ratio combining (MRC) to combine the output signals obtained from each finger. More generally, other combining methods are possible, including but not limited to equal gain combining (EGC), selection combining (SC), switch-and-stay combining (SSC) or other non-linear methods based on probabilistic strategies or other maximization criteria. In some embodiments combining is performed based on a sum of partial statistics for each finger; in other embodiments, the combining is performed based on the partial statistics for the fingers collectively.

The Rake receiver of FIG. 3 comprises a plurality of fingers, referred to as finger 0 50, finger 1 52, . . . , finger L−1 54. Each finger produces a respective output that is fed to a respective p-omr or p-omatlr correlator output transform 56,58, . . . , 60. The outputs of the transforms are input to an MRC combiner 62 the output of which is fed to a decision function 64 which produces the overall output at 68. There are additional components to the Rake receiver that would be similar to those of FIG. 2, not shown in the interest of simplifying a drawing. Each finger has a correlator that multiplies the received signal 66 by a respective pulse delayed by the appropriate delay for the particular multipath component. In some embodiments, the shaping parameter is optimized on a per finger basis. Alternatively, a common value is used for all fingers. As for the optimal threshold, in some embodiments, the optimal value is optimized on a per finger basis.

The operation of the Rake receiver of FIG. 3 will now be described by way of example. Let the length of repetition code be Nₛ, and say the mth chip correlator output in the ith finger can be well approximated by a Laplacian distributed RV (i.e. \hat{p}=1). The disturbance terms in different frames are i.i.d., and are assumed to be independent of the signal. Let r_{m,i} denote the chip correlator output of the mth frame in the ith finger of the Rake receiver. The pdf of r_{m,i} in this case is

$${f}_{{r}_{m , i}} ( x ) = \frac{1}{2 b} exp ( - \frac{\vert x - {S}_{m} \vert}{b} ) \qquad ( 47 )$$

and the cumulative density function (cdf) can be written as

$${F}_{{r}_{m , i}} ( x ) = \frac{1}{2} [ 1 + sgn ( x - {S}_{m} ) ( 1 - exp ( - \frac{x - {S}_{m}}{b} ) ) ] \qquad ( 48 )$$

where the mean of r_{m,i} is E(r_{m,i})=Sₘ, and the variance is var(r_{m,i})=2b². The decision statistic, rᵢ, in this finger of the matched filter based Rake receiver can be represented

$${r}_{i} = {\sum }_{m = 0}^{{N}_{s} - 1} {r}_{m , i} . \qquad ( 49 )$$

The mean of rᵢ is

$$E ( {r}_{i} ) = E ( {\sum }_{m = 0}^{{N}_{s} - 1} {r}_{m , i} ) = {N}_{s} E ( {r}_{m , i} ) = {N}_{s} {S}_{m} \qquad ( 50 )$$

and the variance is

var(rᵢ)=Nₛ·var(r_{m,i})=2NₛB². (51)

Noting that the SINR of the decision statistic X in a transmission system is given by SINR=E²(X)σₓ², the SINR in ith finger of the matched filter based Rake receiver can be expressed as

$${SINR}_{i , mf} = \frac{{E}^{2} ( {r}_{i} )}{var ( {r}_{i} )} = {N}_{s} \cdot \frac{{S}_{m}^{2}}{2 {b}^{2}} . \qquad ( 52 )$$

Consider now the new Rake receiver structure shown in FIG. 3. For the sake of example, the shape parameter is assumed to be well approximated by 1, the p-omr in each Rake finger becomes the soft-limiting UWB receiver. The analysis here focuses on the p=1 case, but performance results for arbitrary p are provided below; in practice the p-omr or p-omatlr are implemented in a Rake receiver with adaptive p. Thus, in each Rake finger, the new chip correlator output \tilde{r}_{m,i} is obtained from r_{m,i} through the transform

$${\tilde{r}}_{m , i} = \{ \begin{matrix}{S}_{m} , & if {r}_{m , i} \geq {S}_{m} \\ {r}_{m , i} , & if - {S}_{m} < {r}_{m , i} < {S}_{m} \\ - {S}_{m} , & if {r}_{m , i} \leq - {S}_{m} .\end{matrix} \qquad ( 53 )$$

The mean of the new chip correlator output \tilde{r}_{m,i} is

$$E ( {\tilde{r}}_{m , i} ) = {\int }_{- ∞}^{+ ∞} {xf}_{{\tilde{r}}_{m , i}} ( x ) d x = {S}_{m} - \frac{b}{2} ( 1 - exp ( - \frac{2 {S}_{m}}{b} ) ) \qquad ( 54 )$$

and its variance is

$$\begin{matrix}var ( {\tilde{r}}_{m , i} ) = E ( {\tilde{r}}_{m , i}^{2} ) - {E}^{2} ( {\tilde{r}}_{m , i} ) \\ = \frac{3}{4} {b}^{2} - ( 2 {bS}_{m} + {b}^{2} / 2 ) {e}^{- 2 {S}_{m} / b} - \frac{{b}^{2}}{4} {e}^{- 4 {S}_{m} / b}\end{matrix} \qquad ( 55 )$$

The decision statistic in ith finger of the new Rake receiver can be represented as

$${\tilde{r}}_{i} = {\sum }_{m = 0}^{{N}_{s} - 1} {\tilde{r}}_{m , i} \qquad ( 56 )$$

and, therefore, the mean of the new decision statistic \tilde{r}ᵢ is

$$E ( {\tilde{r}}_{i} ) = E ( {\sum }_{m = 0}^{{N}_{s} - 1} {\tilde{r}}_{m , i} ) = {N}_{s} \cdot E ( {\tilde{r}}_{m , i} ) \qquad ( 57 )$$

and the variance is

var(\tilde{r}ᵢ)=Nₛ·var(\tilde{r}_{m,i}) (58)

where E(\tilde{r}_{m,i}) and var(\tilde{r}_{m,i}) are given by (54) and (55), respectively. The SINR in the ith finger of the new Rake receiver can, thus, be expressed as

$$\begin{matrix}{SINR}_{i , new} = \frac{E ( {\tilde{r}}_{i} )}{var ( {\tilde{r}}_{i} )} \\ = {N}_{s} \cdot \frac{{S}_{m}^{2} - {S}_{m} b ( 1 - {e}^{- 2 {S}_{m} / b} ) + \frac{{b}^{2}}{4} ( 1 - {e}^{- 4 {S}_{m} / b} )}{\frac{3}{4} {b}^{2} - ( 2 {bS}_{m} + {b}^{2} / 2 ) {e}^{- 2 {S}_{m} / b} - \frac{{b}^{2}}{4} {e}^{- 4 {S}_{m} / b}} .\end{matrix} \qquad ( 59 )$$

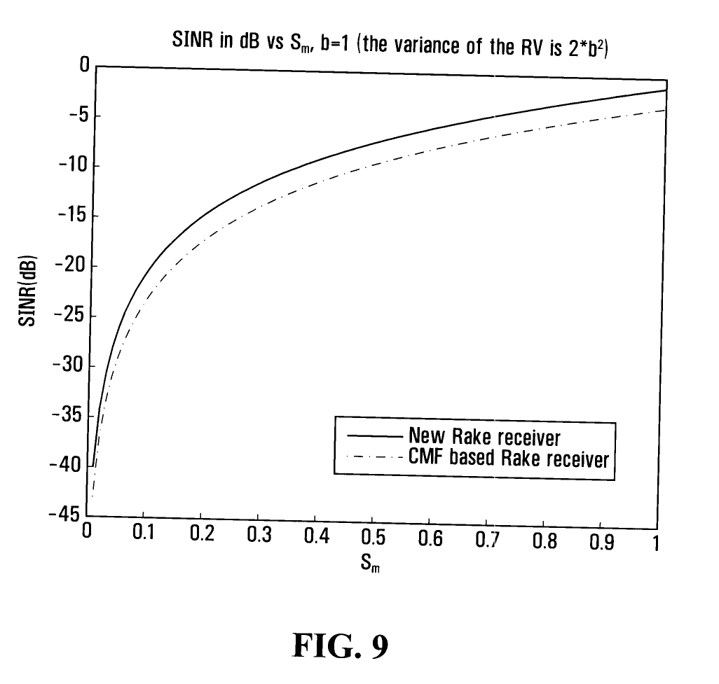

Eq. (52) gives the SINR in each finger of the CMF based Rake receiver, while that of the new Rake receiver adopting the p-omr is given in (59). These two SINRs are compared in FIG. 9. The factor Nₛ is omitted since it does not affect the results of the comparison. Observe that the new Rake receiver has substantial SINR gain, more than 3 dB, over the conventional Rake receiver for all values of Sₘ, and that the SINR gain is monotonically increasing with SINR. Using asymptotic analysis for small and large values of SINR with (59) and (54) gives the results that the SINR gain is 2=3.01 dB for small values of SINR, and 8/3=4.26 dB for large values of SINR. If MRC diversity is employed to combine the signals obtained from each Rake finger, the final decision statistic is r_{final}a₀r₀+a₁r₁+ . . . +a_{L-1}r_{L-1}, where L is total number of fingers in the Rake receiver. In MRC, the gain of each finger aᵢ is proportional to the rms signal and inversely proportional to the mean square noise in that finger, and the SINR for the final decision statistic r is

$${SINR}_{final} = {\sum }_{i = 0}^{L - 1} {SINR}_{i} .$$

Since the value of SINR_{i,new} is between 2 times and 8/3 times SINR_{i,mf} for all values of i,

$$2 \cdot {SINR}_{final , mf} \leq {SINR}_{final , new} \leq \frac{8}{3} \cdot {SINR}_{final , mf} . \qquad ( 60 )$$

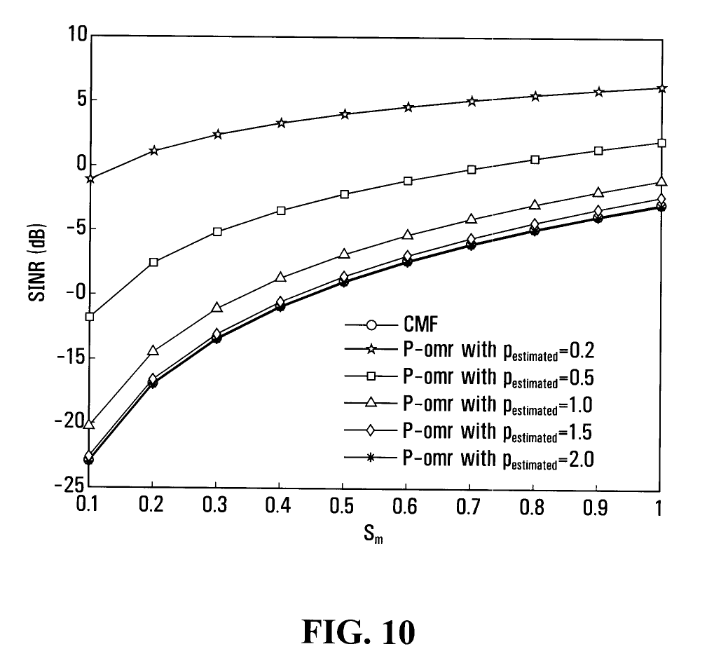

Thus, when measured in dB, the SINR gains of the final decision statistic of the new Rake receiver based on the design of p-omr over the standard matched filter Rake receiver are lower bounded by 3 dB and upper bounded by 4.26 dB. In practical UWB systems with small to medium SINR values, the SINR gains will be around 3 dB when p is close to 1. The preceding discussion valid for p=1 clarifies the mechanism of the SINR improvement. There is also a SINR gain for the p-omr for other values of p, as shown by the results in FIG. 10. FIG. 10 shows the output SINRs in each finger of the CMF based Rake receiver, and those of the p-omr, when the estimated shape parameter \hat{p} in the system equals 0.2, 0.5, 1.0, 1.5 and 2.0 obtained numerically. It is seen that the SINR gains of the new Rake receiver are significant when p is small, and decrease as \hat{p} gets close to 2. For example, the gain for the p-omr with \hat{p}=0.2 over the CMF is as much as 20 dB. As for systems with \hat{p}=0.5, the largest SINR gain decreases to 11 dB. The SINR curves for the new Rake receiver and the CMF based Rake receiver agree perfectly when \hat{p}=2, and the SINR gains are 0 in this case.

Note that, as long as the multipath components in UWB channels are resolvable so that the Rake receiver is viable, the new design of the Rake receiver based on the p-omr or p-omatlr always performs at least as well as the matched filter based Rake receiver (when \hat{p}=2, the SINR gain is 0 dB, and the new Rake receiver becomes exactly the same as the CMF based Rake receiver). The fact that the new Rake receiver adopting the p-omr or p-omatlr in each Rake finger can achieve larger SINR values than the CMF based Rake receiver makes the designs of the p-omr and p-omaltr valuable not only in ideal free-space propagation (AWGN) channels, but also in multipath UWB channels.

### Performance Results and Discussion—Part I

The average bit error rate (BER) performance of the p-omr is evaluated and compared to the conventional matched filter UWB receiver, the soft-limiting UWB receiver which was recently proposed in N. C. Beaulieu and B. Hu, “A Soft-limiting receiver structure for timehopping UWB in multiple access interference,” in Proc. 9th International Symposium on Spread Spectrum Techniques and Applications (ISSSTA), Manaus, Brazil, Aug. 28-31, 2006, and the adaptive threshold soft-limiting UWB receiver proposed in N. C. Beaulieu and B. Hu, “An Adaptive Threshold Soft-Limiting UWB Receiver with Improved Performance in Multiuser Interference”, to be presented at 2006 International Conference on Ultra-Wideband (ICUWB), Massachusetts, USA, Sep. 24-27, 2006. The signal waveform is restricted to the second-order Gaussian monocyle with parameters given in Table I as follows:

TABLE I
PARAMETERS OF THE UWB SYSTEM

| Parameter | Notation | Values |
|---|---|---|
| Time Normalization Factor | τₚ | 0.2877 ns |
| Frame width | T_{f} | 20 ns |
| Chip width | T_{c} | 0.9 ns |
| No. of Users | Nᵤ | 4 |
| No. of Chips per Frame | Nₕ | 8 |
| Repetition Code Length | Nₛ | 4 |

The SIR and SNR are defined as

$$\begin{matrix}SNR = \frac{{E}_{b}}{{N}_{0}} & ( 61 ) \\ \begin{matrix}SIR = \frac{{A}_{1}^{2} {E}_{b} {N}_{s}}{var [ I ]} \\ = \frac{{A}_{1}^{2} {N}_{s}}{{σ}_{1}^{2} {\sum }_{k = 2}^{{N}_{u}} {A}_{k}^{2}}\end{matrix} & ( 62 )\end{matrix}$$

where σ₁² defined as

$$\begin{matrix}{σ}_{1}^{2} = \frac{1}{{T}_{f}} {\int }_{- ∞}^{+ ∞} {[ {\int }_{- ∞}^{+ ∞} p ( x - t ) p ( x ) d x ]}^{2} d t \\ = \frac{1}{{T}_{f}} {\int }_{- ∞}^{+ ∞} {R}^{2} ( t ) d t\end{matrix} \qquad ( 63 )$$

and where R(t) is the autocorrelation function of the second-order Gaussian monocycle.

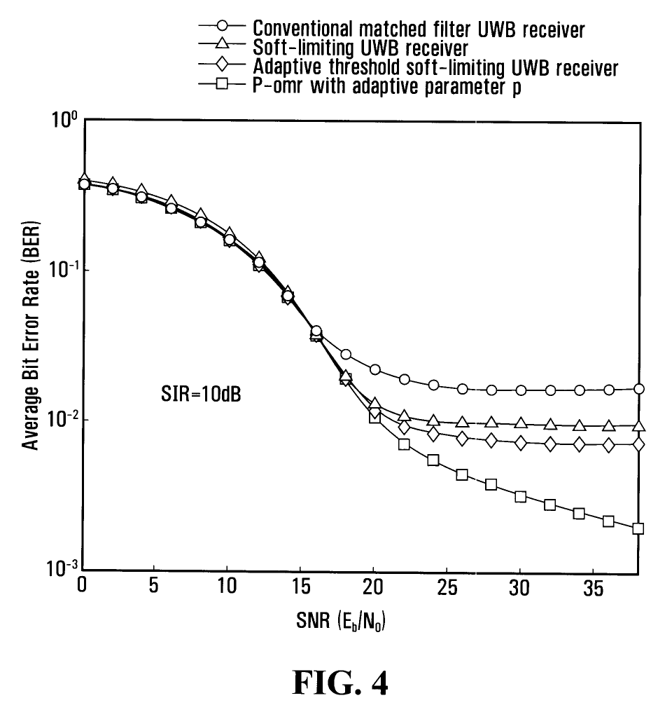

FIG. 4 shows the BER curves of the conventional matched filter UWB receiver, the soft-limiting UWB receiver with fixed threshold and the p-omr operating in a practical environment where both MAI and AWGN are present. For the p-omr, the value of the parameter p is selected to minimize the BER using a computer search. Since the p-omr becomes exactly the same as the conventional matched filter UWB receiver by setting p to 2 and the same as the soft-limiting UWB receiver by setting p to 1, the p-omr can always meet or outperform the other two UWB receivers. Observe that when the SNR is small, i.e. the AWGN dominates the MAI, the overall disturbance in a single frame Yₘ=Nₘ+Iₘ can be approximated as a Gaussian distributed RV, and the conventional matched filter UWB receiver works almost as an optimal receiver. Under such circumstances, the p-omr can only adjust its parameter p to meet the BER performance of the conventional matched filter UWB receiver. As the SNR gets larger and larger to the point where the background noise stops dominating the MAI, the BER performance of the soft-limiting UWB receiver begins to surpass that of the conventional matched filter UWB receiver. The p-omr catches up with the BER performance of the soft-limiting UWB receiver in this SNR region by changing the parameter p from 2 to those values close to 1. After the SNR reaches 20 dB, the BER curves of the conventional matched filter UWB receiver and the soft-limiting UWB receiver both reach error rate floors while the BER curve of the p-omr keeps decreasing. The performance gains are significant in this SNR region. For example, when SNR=38 dB, the BER of the p-omr is 2×10⁻³, which is 9 times smaller than the BER of the conventional matched filter UWB receiver 1.8×10⁻², and 4.75 times smaller than the BER of the soft-limiting UWB receiver (9.5×10⁻³). Note that the p-omr slightly underperforms the adaptive threshold soft-limiting UWB receiver when the SNR is around 16 dB. A new degree of freedom, the threshold Sₘ, could also be introduced to the p-omr to improve its BER performance as subsequent results will show.

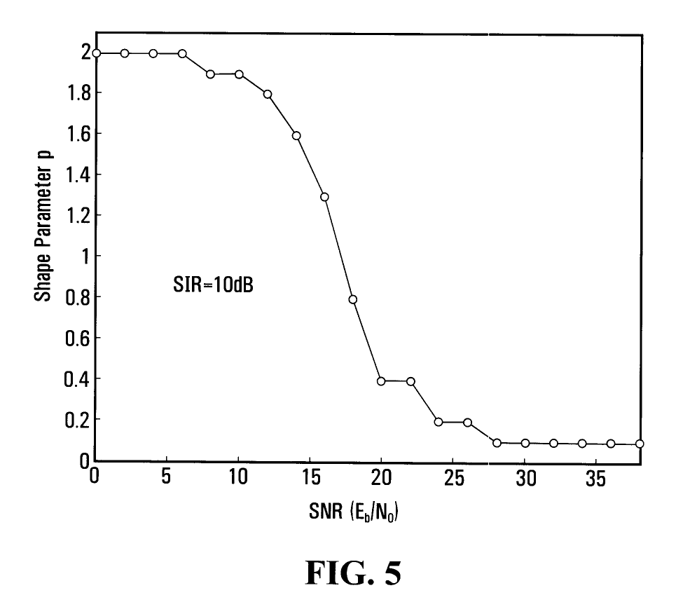

FIG. 5 shows the optimal value of the parameter p for the example of FIG. 4. It is seen that, when the AWGN dominates the MAI, where Yₘ=Nₘ+Iₘ can be approximated as a Gaussian distributed RV, the optimal p is 2, which makes the p-omr exactly the same as the conventional matched filter UWB receiver. The optimal value of p gets smaller as the SNR gets larger and larger and the MAI becomes more and more significant in Yₘ=Nₘ+Iₘ. When the SNR is large enough to make the MAI dominate the AWGN, the optimal value of p can be well approximated by 0.1.

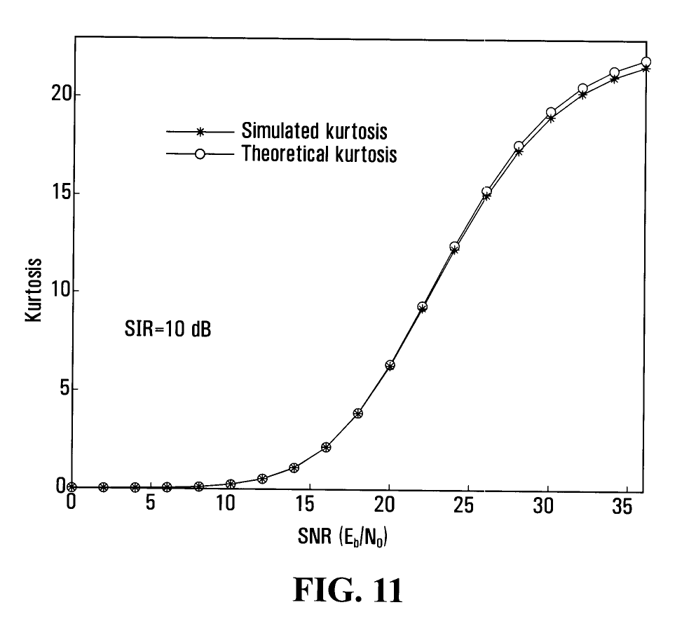

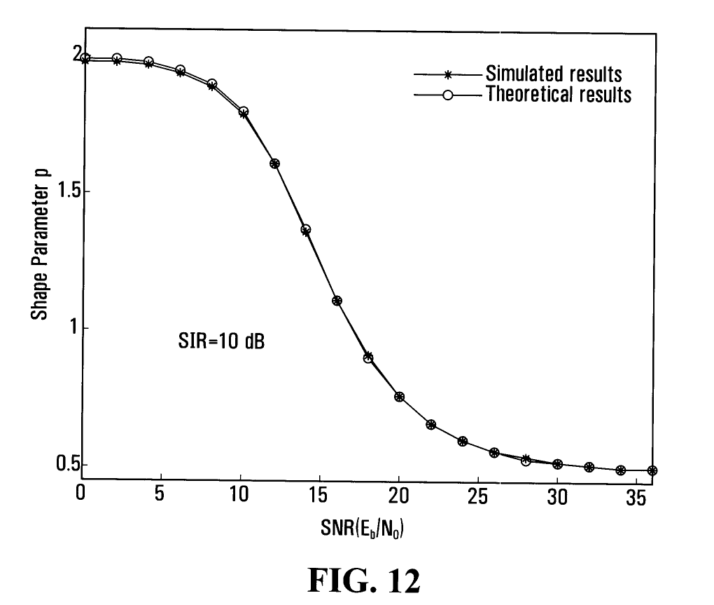

The above performance results are for the p-omr with shape parameter determined by computer search. The kurtosis matching method can also used to determine the optimal shape parameter for the p-omr. FIG. 11 shows the kurtosis of Yₘ obtained by simulation and exact calculation based on the analysis before, when both MAI and AWGN are present in the channel. The SIR is fixed to be 10 dB while the SNR ranges from 0 dB to 36 dB. Note that there is a small difference between the simulated results and the theoretical values caused by the simplifying assumption we adopted in the theoretical analysis. FIG. 12 shows the estimates of the shape parameter p obtained from the simulation and theoretical estimates of the kurtosis for the example of FIG. 11. It is seen that the two estimates of the shape parameter p are very close. The performance of the p-omr with the shape parameter p determined using the kurtosis matching method will be evaluated and compared to the other UWB receivers in the sequel.

### Performance Results and Discussion—Part II

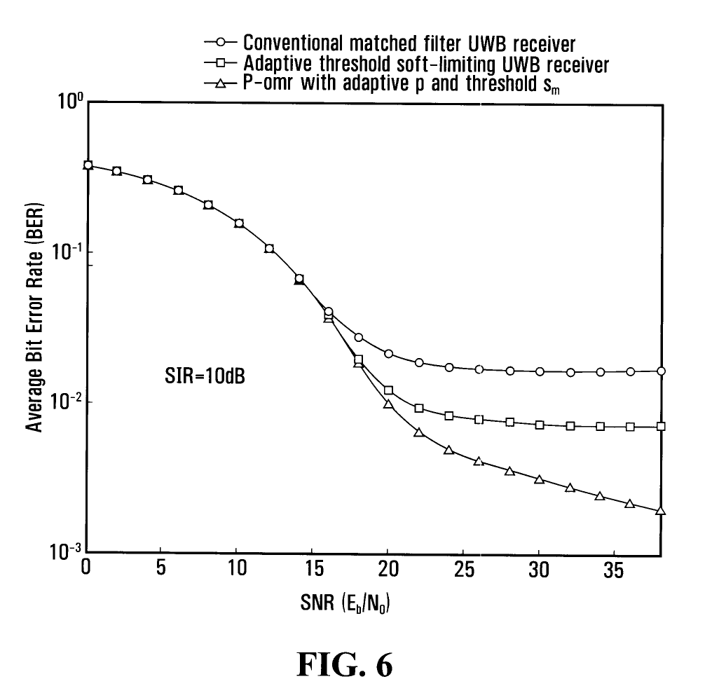

FIG. 4 shows that while the soft-limiting UWB receiver underperforms the conventional matched filter UWB receiver for small values of SNR, the adaptive threshold soft-limiting UWB receiver proposed in N. C. Beaulieu and B. Hu, “An Adaptive Threshold Soft-Limiting UWB Receiver with Improved Performance in Multiuser Interference”, to be presented at 2006 International Conference on Ultra-Wideband (ICUWB), Massachusetts, USA, Sep. 24-27, 2006 improves its BER performance and outperforms the conventional matched filter UWB receiver for all SNR values by making the threshold Sₘ adaptive. In the similar fashion, a new degree of freedom, the threshold Sₘ, can also be introduced to the p-omr. In this case, both the parameter p and the threshold Sₘ are selected to minimize the BER using a computer search or by using channel state information or other means. The p-omr with p=1 and adaptive threshold becomes exactly the same as the adaptive threshold soft-limiting UWB receiver. Thus, the BER performance of the p-omr should always be at least as good as those of the other two UWB receivers. FIG. 6 shows the BER curves of the conventional matched filter UWB receiver, the adaptive threshold soft-limiting UWB receiver and the p-omatlr. For the p-omatlr, the shape parameter p and threshold Tₒₚₜ, are both optimized using computer search according to different values of SNR and SIR. Similarly, when the SNR is small, can be well approximated by a Gaussian RV, and the conventional matched filter is almost the optimal receiver. In this case, the adaptive threshold UWB receiver and the new UWB receiver can only adjust their adaptive parameters to meet the performance of the conventional matched filter UWB receiver. As the SNR gets larger, both the adaptive threshold soft-limiting UWB receiver and the new UWB receiver outperform the conventional matched filter. After the SNR reaches 20 dB, the conventional matched filter UWB receiver and the adaptive threshold soft-limiting UWB receiver reach the error rate floors of 1.8×10⁻² and 7.3×10⁻³, respectively, while the BER curve of the p-omr keeps decreasing and significantly lowers the BER for the large values of SNR. For example, when SNR=38 dB, the BER of the new UWB receiver is 2×10′, which is 1/9 and 20/73 of the BER of the conventional matched filter UWB receiver and the adaptive threshold soft-limiting UWB receiver, respectively. The p-omr does reach an error floor, but not until values of SNR above 70 dB. So, in practical sense, the p-omr does not have an error rate floor because such high values of SNR can not be achieved.

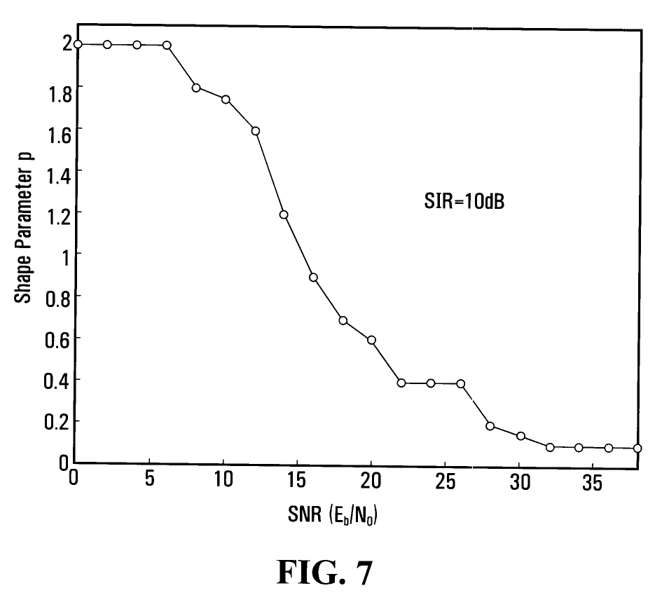

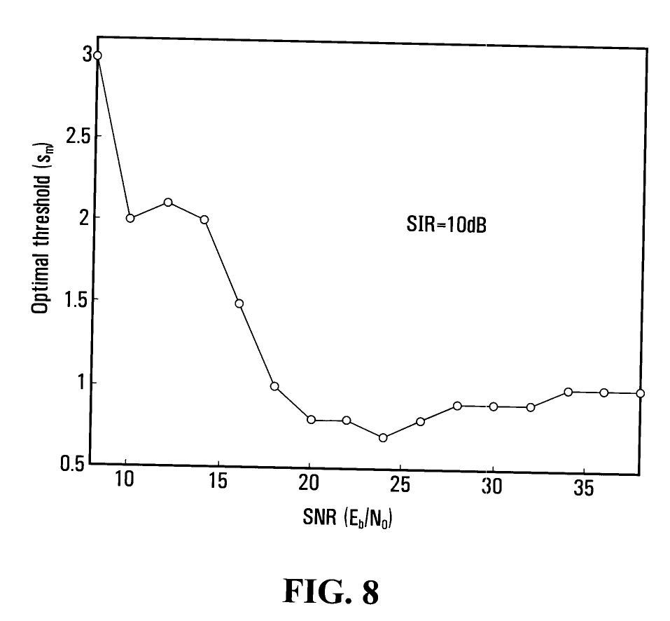

FIG. 7 shows the optimal values of p for different SNRs. The curve changes in the same manner as the curve in FIG. 5. The optimal values of p are close to 2 for small SNRs where the disturbance is approximately Gaussian distributed. It grows smaller with the increasing SNR and is well approximated by the value of 0.1 for large SNR values. Note that with p=2, the new UWB receiver is always exactly the same as the conventional matched filter no matter what value the threshold Sₘ assumes. Thus, in the SNR region [0 dB, 6 dB] where the optimal p equals 2, the threshold search for the p-omr is not necessary. FIG. 8 shows the optimal thresholds Tₒₚₜ of the p-omatlr for the example of FIG. 6 in the SNR region [8 dB, 38 dB]. With the optimal p and threshold Tₒₚₜ, the p-omatlr always meets or outperforms the conventional matched filter UWB receiver and the adaptive threshold UWB receiver as shown in FIG. 6.

The average bit error rate (BER) performances of the p-omr and the p-omatlr are evaluated and compared to the performances of the CMF UWB receiver, the soft-limiting UWB receiver, and the adaptive threshold soft-limiting UWB receiver. The signal waveform is restricted to the second-order Gaussian monocyle and the system parameters are the same as the first set given in Table I above.

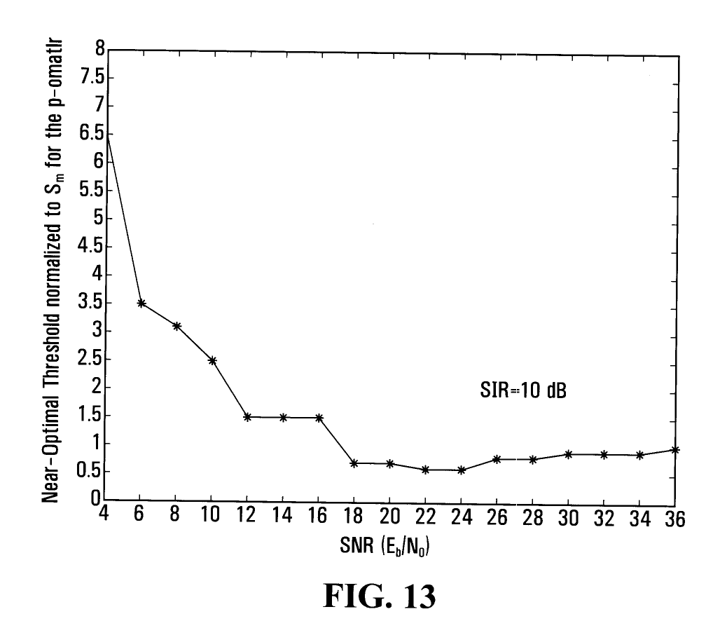

As mentioned before, FIG. 11 shows the kurtosis of Yₘ obtained by simulation and exact calculation based on the analysis before, when both MAI and AWGN are present in the channel. The SIR is fixed to be 10 dB while the SNR ranges from 0 dB to 36 dB. Note that there is a small difference between the simulated results and the theoretical values caused by the simplifying assumption we adopted in the theoretical analysis. FIG. 12 shows the estimates of the shape parameter p obtained from the simulation and theoretical estimates of the kurtosis for the example of FIG. 11. It is seen that the two estimates of the shape parameter p are very close. Regarding the p-omatlr, the optimal threshold Tₒₚₜ can be determined once the shape parameter p has been obtained. Note that with p=2, the p-omatlr is exactly the CMF regardless what value the threshold Tₒₚₜ assumes. Thus, in the SNR region [0 dB, 4 dB] for the example of FIG. 12 where the estimated value of p nearly equals 2, threshold adjustments are not necessary for the p-omatlr. Generally, a threshold adjustment for Tₒₚₜ is required. FIG. 13 shows the optimal values of the threshold Tₒₚₜ, normalized to Sₘ, of the p-omatlr for the same operating conditions as in FIGS. 12 and 13.

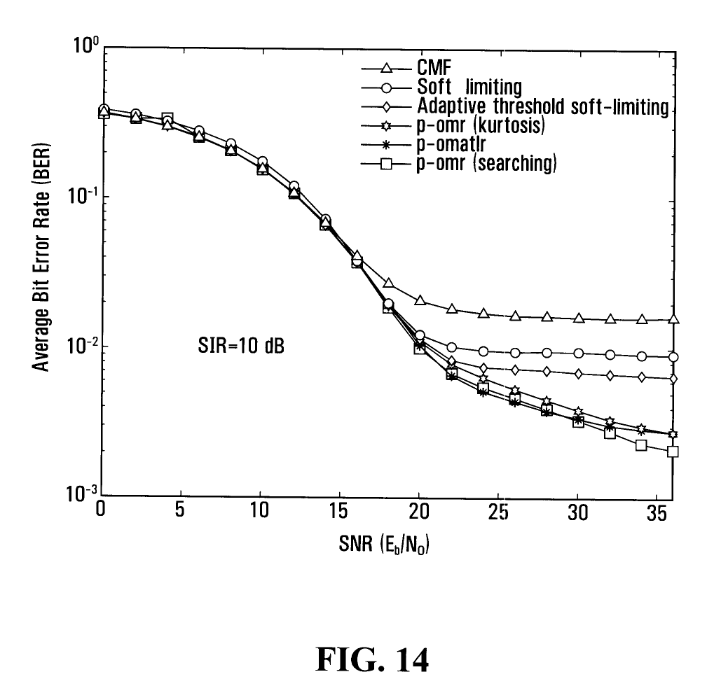

FIG. 14 shows the BER curves of the CMF UWB receiver, the soft-limiting UWB receiver, the adaptive threshold soft-limiting UWB receiver, the p-omr and the p-omatlr operating in a practical environment where both MAI and AWGN are present. For the p-omr, for the purpose of this comparison, the shape parameter p is determined using two different methods. The first method is using the kurtosis matching method. Thus the value of the shape parameter for the p-omr is estimated using the calculation based on eq. (45) and the estimated values of p are those indicated by circles in FIG. 12. The second method is using computer search to find the optimal values of p according to different values of SNR and SIR in the channel. For the p-omatlr, p is first estimated and then the threshold Tₒₚₜ is optimized to minimize the BER using computer search; the values of Tₒₚₜ are shown in FIG. 13. Theoretically, since the p-omr becomes the CMF UWB receiver by setting p to equal 2 and the soft-limiting UWB receiver by setting p to equal 1, the p-omr can always meet or outperform the CMF UWB receiver and the soft-limiting UWB receiver. Furthermore, since the p-omatlr with p=1 becomes the adaptive threshold soft-limiting UWB receiver, the p-omatlr must always perform as well as or better than the adaptive threshold soft-limiting UWB receiver. Observe that when the SNR is small, i.e. the AWGN dominates the MAI, the overall disturbance in a single frame Yₘ=Iₘ+Nₘ can be approximated as a Gaussian distributed RV, and the CMF UWB receiver works essentially as well as an optimal receiver. Under such circumstances, the p-omr and the p-omatlr can adjust the parameter p to meet the BER performance of the CMF UWB receiver. As the SNR gets large to the point where the background noise stops dominating the MAI, the BER performance of the soft-limiting UWB receiver and the adaptive threshold soft-limiting UWB receiver begin to surpass that of the CMF UWB receiver. The p-omr and the p-omatlr attain the BER performances of the soft-limiting UWB receiver and the adaptive threshold soft-limiting UWB receiver, respectively, in this SNR region by changing the parameter p from 2 to values close to 1. Note also that when the SNR exceeds 20 dB, the BER curves of the CMF UWB receiver, the soft-limiting UWB receiver, and the adaptive threshold soft-limiting UWB receiver all reach error rate floors while the BER curves of the p-omr and the p-omatlr keep decreasing, attaining significantly smaller BERs for large values of SNR. For example, when SNR=36 dB, the BER of the p-omr and the p-omatlr is 2.8×10⁻³, which is 5.78 times smaller than the BER of the CMF UWB receiver (1.62×10⁻²), 3.25 times smaller than the BER of the soft-limiting UWB receiver (9.1×10⁻³) and 2.35 times smaller than the BER of the adaptive threshold soft-limiting UWB receiver (6.6×10⁻³). The p-omr and the p-omatlr do reach error rate floors, but not until values of SNR above 45 dB. In a practical sense, the p-omr and the p-omatlr do not have error rate floors for this value of SIR, because such large values of SNR cannot usually be achieved in practical wireless systems. Observe that the p-omatlr with adaptive threshold Tₒₚₜ always achieves the best performance in all operating conditions. It is seen in FIG. 14 that the p-omatlr improves the BER performance of the p-omr for all values of SNR. Of particular interest, observe that there is a reduction in BER achieved by the p-omatlr over the p-omr in the SNR region from 18 dB to 35 dB. The improvement is as much as 2.95 dB in SNR, achieved at a BER of 5×10⁻³. Computer search can be used to obtain the value of shape parameter resulting in the best BER performance. This best BER performance is shown in FIG. 14. Note that the p-omr with p estimated by the empirical search gives better BER performance than the p-omr structure based on the kurtosis matching method. This is because the p-omr design is based on the GGA, while the total disturbance in UWB channels is not exactly generalized Gaussian distributed.

Note that while the detailed embodiments described herein apply to TH-UWB, the receiver structure can also be applied to DS-UWB with appropriate modifications.

The detailed examples above assume the new receiver approaches are applied to the reception of a UWB signal. In some embodiments, the UWB signals are as defined in the literature to be any signal having a signal bandwidth that is greater than 20% of the carrier frequency, or a signal having a signal bandwidth greater than 500 MHz. In some embodiments, the receiver approach is applied to signals having a signal bandwidth greater than 15% of the carrier frequency. In some embodiments, the receiver approach is applied to signals having pulses that are 1 ns in duration or shorter. These applications are not exhaustive nor are they mutually exclusive. For example, most UWB signals satisfying the literature definition will also feature pulses that are 1 ns in duration or shorter.

The receiver approach is applied to signals for which a plurality of correlations need to be performed in a receiver.

In a specific example, the method might be applied for a plurality of correlations determined by the repetition code in a UWB receiver. In other applications, the method might be applied for a plurality of correlations in a Rake receiver or a finger of a Rake receiver. That is to say, the correlations might be used across signal chips of a repetition code, across the fingers of a Rake receiver, or the new receiver might be used as a unit in each finger of a Rake receiver.

The embodiments described herein may be applied to wireless signals that physically come in any form. For example, they may be RF signals, or infrared signals to name a few specific examples.

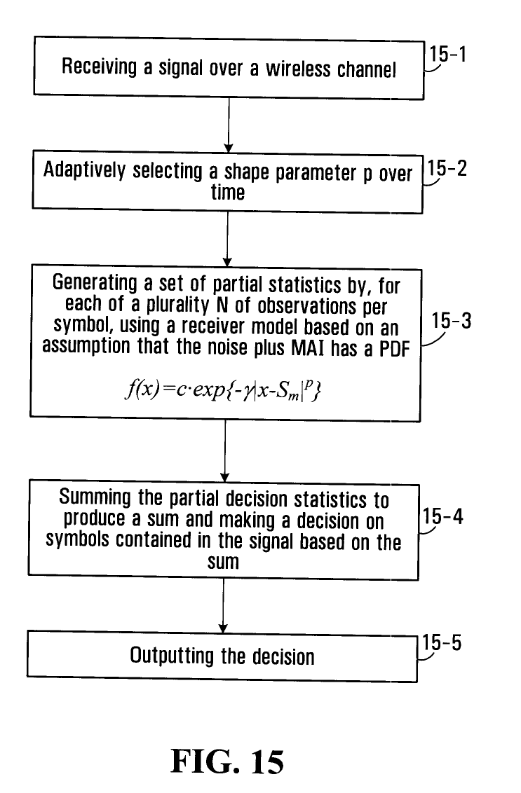

Referring now to FIG. 15, shown is a flowchart of a method of receiving a signal provided by an embodiment of the invention. The method begins at block 15-1 with receiving a signal over a wireless channel. Next, in block 15-2, the receiver adaptively selects a shaping parameter p over time. The method continues in block 15-3 generating a set of partial statistics by, for each of a plurality N of observations per symbol, using a receiver model based on an assumption that the noise plus MAI has a PDF

f(x)=c·exp{−γ|x−Sₘ|^{p}}

where p is the shaping parameter, Sₘ is the mean, and parameter γ is used to adjust the second moment of the RV, and c is a constant to ensure that

$${\int }_{- ∞}^{+ ∞} f ( x ) d x = 1.$$

The method continues at block 15-4 with summing the partial decision statistics to produce a first sum, and making a decision on a symbol contained in the signal based on the first sum. Finally, in block 15-5, a decision is output.

Numerous modifications and variations of the present invention are possible in light of the above teachings. It is therefore to be understood that within the scope of the appended claims, the invention may be practiced otherwise than as specifically described herein.

1. A method of receiving a signal comprising:
receiving a signal over a wireless channel;
adaptively selecting a shaping parameter p over time;
generating a first set of partial statistics by, for each of a plurality N of observations per symbol, using a receiver model based on an assumption that the noise plus MAI has a PDF
f(x)=c·exp{−γ|x−Sₘ|^{p}}
where p is the shaping parameter, Sₘ is the mean, and parameter γ is used to adjust the second moment of the RV, and c is a constant to ensure that
$${\int }_{- ∞}^{+ ∞} f ( x ) d x = 1$$
to generate a respective partial decision statistic of the first set of partial statistics;
summing the partial decision statistics to produce a first sum;
making a decision on a symbol contained in the signal based on the first sum;
outputting the decision.

2. The method of claim 1 wherein for each of a plurality N of observations per symbol, using a receiver model based on an assumption that the noise plus MAI has a PDF
f(x)=c·exp{−γ|x−Sₘ|^{p}}
where the parameter p is adaptive, Sₘ is the mean, and parameter γ is used to adjust the second moment of the RV, and c is a constant to ensure that
$${\int }_{- ∞}^{+ ∞} f ( x ) d x = 1$$
to generate a respective partial decision statistic comprises:
transforming each observation according to:
$$\begin{matrix}{h}_{m} ( {r}_{m} ) = log \{ \frac{f ( {r}_{m} \vert {d}_{0}^{( 1 )} = 1 )}{f ( {r}_{m} \vert {d}_{0}^{( 1 )} = - 1 )} \} \\ = γ {\vert {r}_{m} + {S}_{m} \vert}^{p} - γ {\vert {r}_{m} - {S}_{m} \vert}^{p}\end{matrix}$$
where rₘ is the mth observation.

3. The method of claim 1 further comprising generating each of the plurality N of observations by performing a respective correlation between the received signal at a particular time and a pulse shape.

4. The method of claim 1 wherein adaptively selecting p over time comprising adapting p as a function of SNR.

5. The method of claim 1 wherein adaptively selecting p over time comprises using kurtosis matching.

6. The method of claim 1 wherein adaptively selecting p over time comprises:
measuring a channel condition;
updating p by determining the new value for p as a function of the channel condition.

7. The method of claim 1 wherein adaptively selecting p over time comprises:
maintaining a table lookup of p as a function of a channel condition;
measuring the channel condition;
updating p by looking up the new value for p using the table lookup and the measured channel condition.

8. The method of claim 1 further comprising adapting a value for Sₘ used in the partial decision statistics over time.

9. The method of claim 8 wherein adapting a value for Sₘ used in the partial decision statistics over time comprises adapting a value Tₒₚₜ for Sₘ based on estimated channel conditions or error rate monitoring.

10. The method of claim 1 employed within a rake receiver.

11. The method of claim 10 comprising:
generating a respective set of partial statistics for each of a plurality of multi-path components of the received signal, one of the sets of partial statistics being said first set of partial statistics, by for each of a plurality N of observations per symbol, using a receiver model based on an assumption that the noise plus MAI has a PDF
f(x)=c·exp{−γ|x−Sₘ|^{p}}
where p is the shaping parameter, Sₘ is the mean, and parameter γ is used to adjust the second moment of the RV, and c is a constant to ensure that
$${\int }_{- ∞}^{+ ∞} f ( x ) d x = 1$$
to generate a respective partial decision statistic;
for each multi-path component, summing the partial decision statistics to produce a respective decision statistic, one of the sums being the first sum;
combining the sums to produce an overall decision statistic;
wherein making a decision on a symbol contained in the signal based on the sum comprises making a decision based on the overall decision statistic.

12. The method of claim 11 wherein making a decision on a symbol contained in the signal based on the sum comprises making a decision based on the overall decision statistic comprises performing maximum ratio combining.

13. The method of claim 1 wherein receiving a signal comprises receiving a signal having a signal bandwidth that is greater than 20% of the carrier frequency, or receiving a signal having a signal bandwidth greater than 500 MHz.

14. The method of claim 1 wherein receiving a signal comprises receiving a signal having a signal bandwidth greater than 15% of the carrier frequency.

15. The method of claim 1 wherein receiving a signal comprises receiving a signal having pulses that are 1 ns in duration or shorter.

16. The method of claim 1 wherein receiving a signal comprises receiving a UWB signal.

17. The method of claim 1 wherein receiving a signal comprises receiving a TH UWB signal.

18. The method of claim 1 wherein receiving a signal comprises receiving a DS UWB signal.

19. A receiver operable to implement the method of claim 1.

20. A computer readable medium having instructions stored thereon for implementing the method of claim 1.

21. A receiver comprising:
a correlator configured to generate a first set of partial statistics by, for each of a plurality N of observations per symbol, using a receiver model based on an assumption that the noise plus MAI has a PDF
f(x)=c·exp{−γ|x−Sₘ|^{p}}
where p is a shaping parameter, Sₘ is the mean, and parameter γ is used to adjust the second moment of the RV, and c is a constant to ensure that
$${\int }_{- ∞}^{+ ∞} f ( x ) d x = 1$$
to generate a respective partial decision statistic of the first set of partial statistics;
a channel estimator configured to adapt the shaping parameter over time;
an accumulator configured to sum the partial decision statistics to produce a first SUM;
a decision block configured to make a decision on a symbol contained in the signal based on the first sum;
an output for outputting the decision.

22. The receiver of claim 21 further comprising at least one antenna.

23. The receiver of claim 21 further configured to adapt the mean Sₘ over time.

24. A rake receiver comprising the receiver of claim 21.

25. A method of receiving a signal using a rake receiver, the method comprising:
receiving a signal over a wireless channel;
adaptively selecting a shaping parameter p over time;
generating a first set of partial statistics by, for each of a plurality N of observations per symbol, using a receiver model based on an assumption that the noise plus MAI has a PDF
f(x)=c·exp{−γ|x−Sₘ|^{p}}
where p is the shaping parameter, Sₘ is the mean, and parameter γ is used to adjust the second moment of the RV, and c is a constant to ensure that
$${\int }_{- ∞}^{+ ∞} f ( x ) d x = 1$$
to generate a respective partial decision statistic of the first set of partial statistics;
generating a respective set of partial statistics for each of a plurality of multi-path components of the received signal, one of the sets of partial statistics being said first set of partial statistics, by for each of a plurality N of observations per symbol, using a receiver model based on an assumption that the noise plus MAI has a PDF
f(x)=c·exp{−γ|x−Sₘ|^{p}}
where p is the shaping parameter, Sₘ is the mean, and parameter γ is used to adjust the second moment of the RV, and c is a constant to ensure that
$${\int }_{- ∞}^{+ ∞} f ( x ) d x = 1$$
to generate a respective partial decision statistic;
combining the partial decision statistics to produce an overall decision statistic;
wherein making a decision on a symbol contained in the signal based on the sum comprises making a decision based on the overall decision statistic.
